(19) United States
(12) Patent Application Publication
(10) Pub. No.: US 2026/0037632 A1
(43) Pub. Date: Feb. 5, 2026

(54) Program Execution Anomaly Detection for CyberSecurity

(71) Applicant: CYBERSENTRY.AI, INC., Rancho Santa Fe, CA (US)

(72) Inventors: Stanislaw Maria Aleksander Lewak, North Palm Beach, FL (US); Waclaw Tomasz Sierek, Bolechowice (PL); Ian Philip Beeby, New Ross (IE)

(73) Assignee: CYBERSENTRY.AI, INC., Rancho Santa Fe, CA (US)

(21) Appl. No.: 19/355,765

(22) Filed: Oct. 10, 2025

Related U.S. Application Data
(63) Continuation-in-part of application No. 18/634,092, filed on Apr. 12, 2024.
Application No. 18/634,092 is a continuation of application No. 18/485,049, filed on Oct. 11, 2023, now Pat. No. 11,989,296.
(60) Provisional application No. 63/415,852, filed on Oct. 13, 2022.

(51) Int. Cl. G06F 21/56

(52) U.S. Cl. CPC G06F 21/566; G06F 2221/034

(57) ABSTRACT

Different versions of a program are executed in a first mode of operation in accordance with normal operations with only expected behavior to generate different acceptable behavior models indicative of behavior of the program. A difference between acceptable behavior models indicates different risk profiles for the different versions of the program. Risk profiles can be generated by a model explainer. An event that attempts to execute remote code or a delayed event can be detected in a second mode of operation if the event or the delayed event is not included in the acceptable behavior model. Different sequences of events in the first or second mode can be instrumented at different levels of instrumentation to generate or use the acceptable behavior model. The sequences of events can be generated from a stacktrace in the first and second modes. The instrumentation can be performed in hardware by intercepting SYSCALLs.

### RELATED APPLICATIONS

This application is a continuation-in-part of U.S. patent application Ser. No. 18/634,092, filed Apr. 12, 2024, which is a continuation of U.S. patent application Ser. No. 18/485,049, filed Oct. 11, 2023, which claims priority to U.S. Provisional Patent Application No. 63/415,852, filed on Oct. 13, 2022, and entitled, “Program Execution Anomaly Detection System for Cyber Security”, which is hereby incorporated by reference in its entirety and for all purposes.

### BACKGROUND

Software programs are designed to perform certain expected functions and to operate in an expected manner. This expected performance and operation can be described as “normal operation”. However, in relatively complex systems, errors, bugs, weaknesses, and/or vulnerabilities are inevitable and can make the program or computer system it is running on vulnerable to data leaks, malware, and other security breaches or malicious attacks. Conventional approaches to this problem may detect a security breach after it has happened, for example by monitoring for “big picture” anomalies, such as unusual network traffic, CPU usage, memory access, file usage, and/or data usage. Many of these approaches typically involve after-the-fact analysis of log-files, which may be too late to prevent the security breach or other erroneous or unanticipated operation from happening. Other conventional approaches may provide tools that can be used during software development, to analyze the code and identify weaknesses that could potentially be exploited by a malicious actor. For example, a development tool may scan the code, and look for vulnerability to known types of attacks. Still other conventional approaches may be able to detect certain known attacks, such as SQL injections, but cannot detect other behavior that is unanticipated, unintended, or potentially a security breach.

### SUMMARY

In some aspects, the techniques described herein relate to a method including: executing, by one or more computer systems, a first version of a program in a first mode of operation in a controlled environment in accordance with a normal operation with only expected behavior; generating, by the one or more computer systems, a first record of events including a first plurality of sequences of events that occur during the normal operation of the first version of the program; generating, by the one or more computer systems using the first record of events, a first acceptable behavior model that is indicative of normal behavior of flow control, flow status, or data flow of actions performed by the first version of the program that occur during the normal operation with only the expected behavior; executing, by the one or more computer systems, a second version of the program in the first mode of operation in the controlled environment; generating, by the one or more computer systems, a second record of events including a second plurality of sequences of events that occur during operation of the second version of the program in the first mode of operation; generating, by the one or more computer systems using the second record of events, a second acceptable behavior model that is indicative of behavior of flow control, flow status, or data flow of actions performed by the second version of the program that occur during the operation of the second version of the program in the first mode of operation; determining, by the one or more computer systems, a difference between the second acceptable behavior model and the first acceptable behavior model; determining, by the one or more computer systems, that the difference indicates that the second version of the program has a second risk profile that is different from a first risk profile of the first version of the program; and triggering, by the one or more computer systems, a security review of the second version of the program in response to the second risk profile being different from the first risk profile.

In some aspects, the techniques described herein relate to a method including: receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior; generating, using a model explainer, a behavior summary from information extracted from the acceptable behavior model that describes expected behavior of the program; generating a risk profile for the supervised program based on the behavior summary, wherein the risk profile identifies potential risks associated with the supervised program.

In some aspects, the techniques described herein relate to a method including: receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior; executing, by the one or more computer systems, the program in a second mode of operation after the program has been deployed in runtime in a non-isolated, real-world, operational network environment; detecting, by the one or more computer systems during the second mode of operation, a delayed event that can be activated upon a condition having been met, wherein the delayed event is detected by a comparison of the acceptable behavior model with an operational sequence of events that includes the delayed event as a current action during the second mode of operation, and the delayed event is not included in the acceptable behavior model; and not performing the delayed event and generating an alert to stop the executing of the program.

In some aspects, the techniques described herein relate to a method including: receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior; executing, by the one or more computer systems, the program in a second mode of operation after the program has been deployed in runtime in a non-isolated, real-world, operational network environment; detecting, by the one or more computer systems during the second mode of operation, an event that attempts to execute remote code, wherein the event is detected by a comparison of the acceptable behavior model with an operational sequence of events that includes the event as a current action during the second mode of operation, and the event is not included in the acceptable behavior model; and not performing the event and generating an alert to stop the executing of the program.

In some aspects, the techniques described herein relate to a method including: executing, by one or more computer systems, a program in a first mode of operation in a controlled environment in accordance with a normal operation with only expected behavior; generating, by the one or more computer systems, a training record of events including a plurality of training sequences of events that occur during the normal operation of the program; generating, by the one or more computer systems using the training record of events, an acceptable behavior model that is indicative of normal behavior of flow control, flow status, or data flow of actions performed by the program that occur during the normal operation with only the expected behavior; executing, by the one or more computer systems, the program in a second mode of operation after the program has been deployed in runtime in a non-isolated, real-world, operational network environment; determining, by the one or more computer systems, an operational record of events including a plurality of operational sequences of events that occur during the executing of the program in the second mode of operation, each operational sequence of events being obtained at one of a plurality of levels of instrumentation detail, a first level of instrumentation detail being different from a second level of instrumentation detail of the plurality of levels of instrumentation detail, and a first operational sequence of events of the plurality of operational sequences of events including a first current action; comparing, by the one or more computer systems, the first operational sequence of events with the acceptable behavior model; when the comparing step results in a match between the first operational sequence of events and the acceptable behavior model, performing the first current action in the second mode of operation; and when the comparing step does not result in the match between the first operational sequence of events and the acceptable behavior model, not performing the first current action and generating an alert to stop the executing of the program.

In some aspects, the techniques described herein relate to a method including: receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior; executing, by the one or more computer systems, the program in a second mode of operation after the program has been deployed in runtime in a non-isolated, real-world, operational network environment; determining, by the one or more computer systems, an operational sequence of events of the program during execution of the program in the second mode of operation, the operational sequence of events including a current action, and the operational sequence of events being generated from a stacktrace; comparing, by the one or more computer systems, the operational sequence of events with the acceptable behavior model; when the comparing step results in a match between the operational sequence of events and the acceptable behavior model, performing the current action in the second mode of operation; and when the comparing step does not result in the match between the operational sequence of events and the acceptable behavior model, not performing the current action and generating an alert to stop the executing of the program.

In some aspects, the techniques described herein relate to a method including: receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior; executing, by the one or more computer systems, the program in a second mode of operation after the program has been deployed in runtime in a non-isolated, real-world, operational network environment; determining, by the one or more computer systems, an operational sequence of events of the program during execution of the program in the second mode of operation, the operational sequence of events including a current action, the current action including a SYSCALL, the SYSCALL being intercepted by a processor of the one or more computer systems, and the processor transitioning to an interposer to generate the operational sequence of events upon intercepting the SYSCALL; comparing, by the processor running the interposer, the operational sequence of events with the acceptable behavior model; when the comparing step results in a match between the operational sequence of events and the acceptable behavior model, performing the current action in the second mode of operation; and when the comparing step does not result in the match between the operational sequence of events and the acceptable behavior model, not performing the current action and generating an alert to stop the executing of the program.

### BRIEF DESCRIPTION OF THE DRAWINGS

FIG. 1 is a simplified schematic block diagram of an improved program execution anomaly detection system, in accordance with some examples.

FIG. 2 is a simplified block diagram of functional modules for the detection system, in accordance with some examples.

FIG. 3 is a simplified flowchart of an example summary process for generating an acceptable behavior model for use in the detection system shown in FIG. 1, in accordance with some examples.

FIG. 4 is a simplified flowchart of an example summary process for monitoring a supervised program for abnormal behavior by the detection system shown in FIG. 1, in accordance with some examples.

FIG. 5 is a simplified user input/control interface for a user to input control parameters for the detection system shown in FIG. 1, in accordance with some examples.

FIG. 6 is a simplified flowchart of an example summary process for instrumenting and monitoring the supervised program that includes interpreted-language code by the detection system shown in FIG. 1, in accordance with some examples.

FIG. 7 is a simplified flowchart of an example summary process for instrumenting and monitoring the supervised program using a modified compiler by the detection system shown in FIG. 1, in accordance with some examples.

FIG. 8 is a simplified block diagram of a computing system of an example hardware implementation for the detection system shown in FIG. 1, in accordance with some examples.

FIG. 9 is a simplified flowchart of an example summary process for instrumenting and monitoring the supervised program using the hardware implementation for the detection system shown in FIG. 1, in accordance with some examples.

FIG. 10 is a simplified schematic diagram showing an example computer system for use in the detection system shown in FIG. 1, in accordance with some examples.

FIG. 11 is a portion of simplified user input/control interface for a user to input control parameters for the detection system shown in FIG. 1, in accordance with some examples.

FIG. 12 is an illustration of how different sections or types of sections could have different instrumentation granularity requirements, in accordance with some examples.

FIG. 13 is a simplified flowchart of a process for determining whether a new program version introduces new problems in the supervised program, in accordance with some examples.

FIG. 14 is a simplified schematic diagram showing an alternative example computer system for use in the detection system shown in FIG. 1, in accordance with some examples.

### DETAILED DESCRIPTION

The present invention enables an improved system and/or method to detect when a supervised program is about to engage in unanticipated, abnormal, or malicious behavior, i.e., a software anomaly. Then it can halt execution of the supervised program before the unanticipated, abnormal, or malicious behavior can occur. Alternatively, the improved system and/or method may flag that behavior or a current function, action, or event. Thus, the improved system and/or method provides “program behavior enforcement”. In some examples, the present invention detects deviations from normal behavior rather than explicitly malicious actions. In other words, the present invention does not determine what the supervised program could do in all situations, but what the supervised program should do only in normal situations. Additionally, whereas conventional security approaches focus on the security of the computer device, the present invention focuses on the security of an individual program running on the computer device. Thus, the present invention has the potential to be more precise in detecting a security threat.

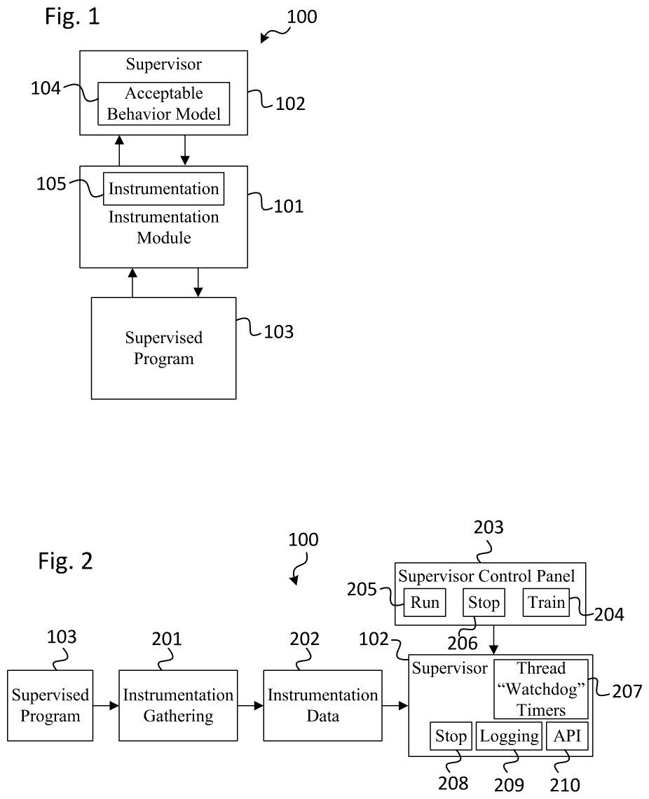

FIG. 1 is a simplified schematic block diagram of an improved program execution anomaly detection system (detection system) 100, in accordance with some examples. The detection system 100 generally includes an instrumentation module 101 and a supervisor (i.e., a sentry) 102 for detecting execution anomalies of a supervised program 103. The two main components (the instrumentation module 101 and the supervisor 102) work together to detect imminent unanticipated or abnormal behavior in the supervised program 103 and to halt, pause and/or flag execution thereof and/or execute one or more exception routines (e.g., that are specified or requested by the supervised program 103) before the unanticipated or abnormal behavior occurs.

In some examples, the instrumentation module 101 generates instrumentation 105 for the supervised program 103, so that the instrumentation 105 can communicate with the supervisor 102 to provide the supervisor 102 (i.e., a pattern detection unit and security system) with information about the behavior of the supervised program 103 (i.e., reports events or actions of the supervised program 103) during both a model-building mode and an operation mode, as discussed below. The model-building mode is a training mode or learning mode that is typically performed in a controlled, captive, isolated, simulated, or sandbox environment for development, debugging, or testing of the supervised program. The operation mode, on the other hand, is a real-world execution mode, monitoring mode, or protection mode when the supervised program is deployed and operating under non-isolated, real-world, non-development, or non-debug circumstances for use in runtime by a customer to monitor the supervised program for, and protect against, malicious, unwanted or unacceptable actions or behaviors. When the supervised program is executed in the operation mode, the detection system 100 generally enforces expected or acceptable behavior and thereby blocks or prevents unexpected behavior that could be malicious or otherwise unacceptable. Techniques for generating the instrumentation 105 by the instrumentation module 101 are discussed below.

In general, the instrumentation module 101 generates instrumentation for the supervised program 103, so that the instrumentation can generate and send to the supervisor 102 information about what the supervised program 103 is doing, i.e., events or actions being performed or about to be performed by the supervised program 103 during either the model-building mode (i.e., a first mode of operation in a controlled environment) or the operation mode (i.e., a second mode of operation in an operational environment). Each recorded event or action is provided in the sequence that they occur. Some examples of such actions or events may include, but not be limited to:
The supervised program 103 is calling a particular function with particular parameters;
The supervised program 103 is returning from a particular function with particular results; or
The supervised program 103 is throwing an exception of a particular kind.

During the model-building mode, the supervisor 102 receives these types of events, among others, from the instrumentation 105 and builds a “normal behavior” model or “acceptable behavior” model 104 (e.g., using artificial intelligence (AI), machine learning (ML), statistical analysis, and/or a heuristic compiler) based on patterns of behavior or sequences of the events that occur during normal operation of the supervised program 103. The acceptable behavior model 104 is, thus, indicative of normal behavior of flow control, flow status, and data flow of actions performed by the supervised program 103 that are allowed, acceptable or expected to occur during the normal operation in the absence of any attack, malicious behavior/actions, anomalous events, or external hostile influences, i.e., it is a built-up picture of the types and range of flow control and other operating parameters which the supervised program 103 would normally use during the operation mode.

During the operation mode, the supervisor 102 receives these events from the instrumentation 105 and compares patterns or sequences of the events (i.e., operational events and operational sequences) to the acceptable behavior model 104, e.g., as inputs to an AI model, statistical analysis, and/or other appropriate pattern detection technique or combinations thereof. This comparison enables the supervisor 102 to determine whether the current or instant action or event or sequence of events matches a pattern or sequence of events that is known or expected to occur during normal operation or behavior of the supervised program 103 or that is known or expected to be representative of normal operation. Thus, the supervisor 102 performs this comparison to determine when there is a match and when there is no match. In some examples, this match need not be exact, but sufficiently close to be accepted as a match, as may be determined empirically during the model-building mode. With the instrumentation 105, therefore, execution of the instrumented supervised program 103 produces a series of signals or messages that indicate the flow control or the flow status within the executing instrumented supervised program 103, and these signals are monitored by the supervisor 102 and compared with the reference of the acceptable behavior model 104 to ascertain whether the instrumented supervised program 103 is executing within or outside expected limits.

When the comparison results in a match between an operational sequence of events and the acceptable behavior model 104, this indicates that no anomaly shall occur or has been detected, so the supervisor 102 generally takes no action in response thereto (or instructs the instrumentation 105 or the supervised program 103 to continue operation), thereby allowing the supervised program 103 to perform the current action or event in normal operation of the supervised program 103. On the other hand, when the comparison does not result in a match between the operational sequence of events and the acceptable behavior model 104 (i.e., the operational sequence of events deviates from the acceptable behavior model 104), this indicates that an anomaly (that would occur if execution of the supervised program 103 were to continue) has been detected. In this case, the supervisor 102 responds with an action to cause the supervised program 103 not to perform the current action or event. In some examples, the supervisor 102 generates an alert to stop or pause the execution of the program or of the anomalous program behavior. Therefore, the supervisor 102 sends information back to the supervised program 103 or the instrumentation 105, for example (but not limited to), that the supervised program 103 should be terminated or paused during operation mode, the current action/event should be flagged, and/or one or more predetermined exception routines should be run (e.g., by the supervised program 103).

Conventional uses of instrumented executable code generally search for a known type of vulnerable or unsafe function/state or malicious action that could be performed by the code, e.g., as can be determined from a control flow graph and/or data flow model. The control flow graph or data flow model, for example, may be generated to attempt to determine all possible actions or events that a program could make or states that the program could enter in all situations. This enables analysis for potential vulnerabilities or attack vectors that a malicious actor could exploit. Then the program developer can debug the program by changing the code to make sure that the vulnerability does not show up in a final control flow graph, thereby removing or curing the vulnerability. Such conventional techniques require knowledge of characteristics of potential vulnerabilities or attack vectors, the structure of the program, and the full capabilities the program, so that the analysis of the control flow graph or data flow model can detect the potential vulnerabilities or attack vectors. The present invention, on the other hand, has the advantage of not requiring such knowledge, because the present invention is not explicitly looking for vulnerabilities, attack vectors, or potentially malicious actions in the code of the supervised program 103. Instead, the present invention beneficially looks for normal behavior of the supervised program 103, regardless of any potential vulnerabilities in the code, so that it can detect deviations from such normal behavior. In the model-building mode, the detection system 100 is not concerned with the full capabilities the supervised program 103 and might not encounter all possible actions, events, sequences or states that the supervised program 103 is potentially capable of. However, the actions, events, sequences or states that are encountered during the model-building mode would necessarily be part of normal operation, so that the acceptable behavior model 104 generated therefrom can be used to compare with operational events and operational sequences during the operation mode. In other words, the present invention detects deviations from normal behavior rather than explicitly malicious actions. Stated another way, the present invention does not determine what the supervised program 103 could do in all situations, but what the supervised program 103 should do only in normal situations.

In accordance with the above description, FIG. 2 is a simplified block diagram of functional modules for the detection system 100, in accordance with some examples. During the model-building mode and the operation mode, functions, actions, or events performed by the supervised program 103 are provided to an instrumentation gathering module 201 of the instrumentation 105. The instrumentation gathering module 201 gathers this information to produce instrumentation data 202. The instrumentation data 202 is provided by the instrumentation 105 to the supervisor 102.

A supervisor control panel 203 provides a “train” or “model-building” signal 204 to the supervisor 102 for the supervisor 102 to operate in the model-building mode to generate or train the acceptable behavior model 104. The supervisor control panel 203 also provides a “run” signal 205 to the supervisor 102 for the supervisor 102 to operate in the operation mode to detect anomalies in the actions or events of the supervised program 103 based on the acceptable behavior model 104. The supervisor control panel 203 also provides a “stop” signal 206 to the supervisor 102 for the supervisor 102 to terminate or pause operations by the supervised program 103, the instrumentation module 101, and/or the supervisor 102 in either mode.

The supervisor 102 includes thread timers 207 (e.g., “watchdog” timers) that are set for each thread or process being tracked to ensure that there is an expected response within an expected amount of time. This is used to ensure that the supervised program 103 is running the code as expected. The time duration of some or all of the timers 207 may be set by determining the length of time taken for observed or monitored functions, actions or events to be performed normally during the model-building mode, so that if one of the timers 207 exceeds the previously-determined duration during the operation mode, then this can indicate abnormal behavior or performance or interference with normal operation. In some cases, a response is expected from the instrumentation 105 within a time period monitored by the timers 207, and if the response is not received by the supervisor 102 within the time period, then the halt/termination/flag alert/message is generated as described below. The supervisor 102 also includes a “stop” command 208 that it sends to the instrumentation 105, the supervised program 103, a code interpreter, or the operating system to stop or pause the supervised program 103 (or thread or process thereof) for which the supervisor 102 has detected an anomaly. The supervisor 102 also includes a “logging” function 209 that it uses to provide a signal or record that an anomaly or unexpected behavior has occurred. The supervisor 102 also includes an “API” function 210 that it uses to allow external programs (e.g., via an application programming interface (API)) to perform a function with the supervised program 103 at a signaled state, thereby extending the usefulness of the supervisor 102. An example of such an external program may be a debugger application that can help a programmer understand why the anomaly occurred.

In some examples, communication between the instrumentation module 101 and the supervisor 102 preferably uses high bandwidth with low latency communications so as not to slow down the running of the supervised program 103 too noticeably. Suitable protocols for providing communication may involve, but are not limited to:
A shared memory, wherein the supervisor 102 and the supervised program 103 are running on the same virtual machine (VM) and computing node;
An inter-VM shared memory, wherein the supervisor 102 and the supervised program 103 are running on different VMs but both are running on the same computing node; or
A high performance computing (HPC) interconnect (e.g., remote direct memory access (RDMA), InfiniBand (IB), RDMA over Converged Ethernet (RoCE), etc.), wherein the supervisor 102 and the supervised program 103 may be running on different VMs and different computing nodes as long as there is an HPC interconnect between them.

In some examples, the supervisor 102 can be running together with the instrumentation module 101, the supervised program 103, and the instrumentation 105 in the same process space, however, this is not ideal. Such an approach may expose the supervisor 102 to unlimited access by malicious code that has attacked the supervised program 103. In such a situation, it would be much easier for an unacceptable action by the supervised program 103 or malicious code to possibly circumvent the supervisor 102, thereby preventing detection of an execution anomaly. Thus, a preferred approach provides separation between, i.e., different process spaces for, the supervisor 102 and the instrumentation module 101 for security reasons.

### Instrumentation Module

Implementation of the instrumentation module 101 generally depends on the technology which is used for the supervised program 103, e.g., interpreted languages or compiled languages. For example, the instrumentation module 101 for the supervised program 103 written in the Java programming language differs from the instrumentation module 101 for a program written in the JavaScript programming language which differs from the instrumentation module 101 for a program written in the Python programming language which differs from the instrumentation module 101 for a program written in one of the C or C++ programming languages and so on. In other words, the detection system 100 is optimized for the specific language.

In some examples, for the supervised program 103 written in an interpreted or bytecode language, a modified code interpreter (which includes the instrumentation module 101) generates the instrumentation 105 while it is interpreting the code/program, so the instrumentation 105 includes an instrumented portion of executable code generated by the modified code interpreter using the instrumentation module 101. Alternatively, a code interpreter separate from the instrumentation module 101 can interpret code that has already been instrumented with the instrumentation 105 by the instrumentation module 101, so the instrumentation module 101 includes the capability to instrument the interpreted-language code, and the instrumentation 105 includes an instrumented portion of executable code generated by the code interpreter. In some examples, for the supervised program 103 written in a compiled language, previously compiled code is recompiled (or code is compiled initially) by a modified compiler (which includes the instrumentation module 101) to automatically add the instrumentation 105 to the generated executable code. In some examples, the instrumentation module 101 includes a hardware implementation (optionally in combination with instrumented code of the supervised program 103) that provides the instrumentation 105 to gather the instrumentation data from the executing code of the supervised program 103 and provide it to the supervisor 102. These examples are described in more detail below.

In addition, in some examples, virtual machines (VMs) or code interpreters provide instrumentation facilities for the instrumentation module 101 that could be used (e.g., an instrumentation API for Java) to generate the instrumentation 105. Instrumentation for these technologies, and in general, is well-understood in the art.

In some examples, the instrumentation module 101 identifies functions, events or actions and inserts extra code (i.e., instrumentation code included as the instrumentation 105) at entry, exit and exception points of the supervised program 103 for monitoring execution at these points. For example, this may be done upon compiling or interpreting the code of the supervised program 103 for compiled languages or interpreted languages, respectively. Alternatively, the hardware implementation detects or identifies instrumentation points or locations at which to generate instrumentation data. In some examples, the instrumentation module 101 may identify all functions, or a selected subset of the functions, for the insertion of the extra code. In some examples, program flow control is instrumented in the supervised program 103, along with parameters relevant to program control.

In some examples, when execution (during either the model-building mode or the operation mode) of the supervised program 103 encounters the extra code (by either instrumentation in the compiled code or instrumentation by the code interpreter), the extra code is executed. In so doing, the extra code (i.e., the instrumentation 105) generates and sends messages to the supervisor 102 that execution of the supervised program 103 has reached a given or predetermined point, action or event. Alternatively, the hardware implementation generates and sends the messages. Execution of the supervised program 103 is thus observed by the instrumentation 105. In general, the same types of observations are performed and messages are sent by the instrumentation 105 during both the model-building mode and the operation mode.

In the model-building mode, in some examples, there is typically no need for the supervisor 102 to send messages back to the instrumentation 105 or the instrumentation module 101, so the instrumentation 105 generally proceeds uninterrupted with execution of the supervised program 103. However, in other examples, the instrumentation 105 receives approvals for all requests or messages back from the supervisor 102. In the operation mode, in some examples, after each message is sent, depending on the configuration of the instrumentation 105, the instrumentation 105 may wait for approval from the supervisor 102 before continuing the execution to the next step, function, action or event of the code of the supervised program 103, so that the supervisor 102 can determine whether to immediately halt execution of the supervised program 103 before the instant action or event can be executed. In other examples, the instrumentation 105 may alternatively wait for such approval under some circumstances, for example after a predetermined number of messages, or only for certain functions, or may not wait for approval. In some examples, e.g., for performance reasons, if the instrumentation 105 is configured not to wait for approval, it may get a program termination/stop/kill/pause signal later, if the supervisor 102 subsequently determines that the supervised program 103 should not be allowed to keep running.

In some examples, it is anticipated that, for performance reasons, some types of functions that may appear in the code may not need instrumentation, e.g., functions that are purely computational and do not interact with the environment beyond the supervised program 103 itself. On the other hand, functions that interact with user input, or that control flow, are preferably instrumented. However, it is contemplated that some examples may involve instrumentation of the entire code of the supervised program 103.

During the model-building mode, the instrumentation module 101 runs the supervised program 103 using test cases, which are typically designed by programmers, developers, or users to test the supervised program 103, e.g., with expected normal user interactions, API interactions, file interactions, etc. with the supervised program 103. Additionally, the instrumentation module 101 runs the supervised program 103 (one or more times) as a normal operation in a captive, isolated, or controlled network environment (captive normal operation). In some examples, the captive normal operation is necessary, because the programmers, developers, or users might not anticipate all possible normal scenarios of operation with the design of the test cases, i.e., the test cases might not be “complete”.

In the captive normal operation of the supervised program 103 as used in the model-building mode, the supervised program is tested, but the system is isolated from the outside environment, including, e.g., the public internet or other programs running on the same computer as that of the supervised program 103. In some examples, the model-building mode is conducted in isolation from external influences in an isolated captive network environment in order to avoid the risk of hostile, malicious or anomalous behavior being mistakenly recognized as, and then incorporated in the acceptable behavior model 104 as, acceptable or normal behavior. By monitoring in the isolated captive network environment, the model-building mode ensures that only valid operations can occur, hostile actions or influences are avoided, or the training remains “clean”. Additionally, during the captive normal operation, the training can flag behavior that did not show up when running the test cases, thus providing information that can be used to generate more test cases, directed to this behavior. Using both the test cases and the captive normal operation of the supervised program 103 generally improves the ability of the supervisor 102 to monitor program flow and detect anomalies. Additionally, after the detection system 100 has generated the acceptable behavior model 104 in relation to a particular software package, set of packages and/or system configuration, the acceptable behavior model 104 can be propagated to other suitable or like detection systems 100 located elsewhere without the need for each such device, machine or system to be transported to the captive, isolated, or controlled network environment for training.

### Supervisor

In some examples, the supervisor 102 can run in either mode: the model-building mode or the operation mode. In the model-building mode, the supervisor 102 is trained or taught to interpret and learn from the data of the sequences of events received from the instrumentation 105. In some examples, in this mode, the supervisor 102 approves all requests or messages from the instrumentation 105, and collects the event/sequence data provided by the instrumentation 105 to create the acceptable behavior model 104. The supervisor 102 generally builds an initial version of the acceptable behavior model 104 or enhances an existing version of the acceptable behavior model 104 for the supervised program 103.

In some examples, generating the acceptable behavior model 104 generally involves running representative test cases or examples of normal operation of the supervised program 103 by means of the instrumentation 105, so that the supervisor 102 can learn or establish an envelope of normal or acceptable operation thereof, i.e., a range of normal or acceptable behaviors. (In some examples, the acceptable behavior model 104 is generated or trained, using AI techniques, e.g., with statistical data, to determine whether the current or instant instruction or sequence of events is part of normal, acceptable or anticipated behavior.) In other words, the supervisor 102 uses the acceptable behavior model 104 to determine whether the current or instant instruction should be permitted to proceed to be executed or the supervised program 103 should be terminated. In an example, to make this determination, the acceptable behavior model 104 takes into account information such as the sequence of events (i.e., the call chain or a window of events that includes the current or instant event and a sufficient number of preceding events), the function being called, and the input data for this function, among other possible parameters. Therefore, in the model-building mode, the instrumentation 105 sends messages to the supervisor 102 for normal network package transmissions/receipts, normal file reads/writes, normal database accesses, normal functions calls, and other appropriate normal actions or events that can be performed by the supervised program 103. The supervisor 102, thus, incorporates the data of these messages (as sequences of events at each instrumentation point or location in the execution of the code) into building the acceptable behavior model 104.

During the model-building mode, the supervisor 102 receives the messages of the functions, actions or events and builds the acceptable behavior model 104 based on the patterns of behavior or sequences of the events (i.e., building-mode events and building-mode sequences) for the control flow and/or data flow that occur during normal operation of the supervised program 103, i.e., without any attack, unacceptable behavior, malicious behavior/actions, or anomalous events. In some cases, “normal operation” is considered to occur with only expected, acceptable or non-malicious behavior. These patterns or sequences, thus, become “known”, “reference”, “normal”, or “correct” patterns or sequences that are known to occur during normal operation or behavior of the supervised program 103 or that are known to be representative of normal operation. The acceptable behavior model 104 is, thus, indicative of normal behavior of the supervised program 103 that occurs during the normal operation without any attack, unacceptable behavior, malicious behavior/actions, or anomalous events or with only expected, acceptable or non-malicious behavior. In some examples, the supervisor 102 uses AI to train or generate the acceptable behavior model 104 (i.e., a ML or AI model) based on the model-building-mode events and model-building-mode sequences. The model-building mode, thus, involves inputting multiple patterns or sequences of events to an AI system to train or generate the acceptable behavior model 104. In some examples, the acceptable behavior model 104 involves analyzing data developed or generated by the supervisor 102 for statistical analysis of events or sequences of events that the supervised program 103 may perform during normal operation. In some examples, the AI can include statistical analysis, artificial intelligence, or combination thereof.

After the acceptable behavior model 104 is developed, validated and tested in the model-building mode (which may be an iterative process and may use techniques known in the field), the detection system 100 is deployed to enforce program behavior in the operation mode wherever needed within any number of computerized systems. Therefore, many copies of the supervisor 102 may operate in the operation mode, each using a copy of the acceptable behavior model 104, to determine whether operation of the supervised program 103 is behaving normally or abnormally. During the operation mode, the supervisor 102 receives messages of actions or events from the instrumentation 105 and sends back approvals to continue operations and/or alerts (e.g., an out-of-range alert) to terminate, stop, or pause the executing of the supervised program 103. In some examples, termination occurs before the instant or current event or function (indicated in the most recent message) is performed, immediately after (i.e., before an immediately subsequent event or action) the instant or current event or function is performed, or relatively soon after the instant or current event or function is performed. Additionally, in some examples, in case of a termination signal, the supervisor 102 will preferably also execute operating system level program termination, e.g., to make sure that a potentially compromised supervised program is not allowed to continue to execute.

In some examples, the supervisor 102 determines whether the supervised program 103 should continue to operate or execute in light of the current message from the instrumentation 105 (i.e., the current point of execution of the supervised program 103) and the history or context of execution (i.e., the sequence of events which the supervised program 103 executed before the current point of execution). In this manner, the supervisor 102 does not analyze or observe each event in isolation from other events but within a context among other events and other data. In other words, the supervisor 102 analyzes the current event and the sequence of events (i.e., a number or “window” of sequential events) to which it belongs with either the AI model or the statistical analysis. Thus, the analysis by the supervisor 102 determines the event or events that happen in a given situation or state of the supervised program 103 or following a particular event or history, context, or sequence of events.

The number of events that the analysis uses to form each window or sequence of events (including the current or instant event and preceding events) may be configurable and may depend on a type of the current or instant event, the needs of the acceptable behavior model 104, the performance capabilities of the supervisor 102, and any other appropriate considerations. Additionally, for a relatively small number or short window or sequence of events (e.g., a number determined empirically), the sequence of events may generally be used as-is to generate the acceptable behavior model 104. On the other hand, for a relatively large number or long window or sequence of events (e.g., a number determined empirically), the sequence of events may be compressed using compression algorithms to generate the acceptable behavior model 104, so that during the operation mode, the comparison of operational events or sequences with the acceptable behavior model 104 can be done more quickly or efficiently. Different examples may or may not use such compression. Furthermore, when a sequence of events is found to be repeated by the supervised program 103, then this sequence of events can be stored only once for use in generating the acceptable behavior model 104, thereby reducing the size of the acceptable behavior model 104.

In some examples that use machine learning (ML) or artificial intelligence (AI) for the supervisor 102 to determine whether to continue operation or to terminate operation of the supervised program 103, the AI enables complex behavior (e.g., the anticipated or normal behavior of the supervised program 103) to be modeled, so as to recognize patterns in the sequences of events. The AI model, thus, enables the supervisor 102 to recognize a difference between the anticipated or normal behavior (learned during the model-building mode) and behavior that is not anticipated or normal (encountered during the operation mode). On the other hand, in some examples that use statistical analysis, the statistical analysis is used instead of, or as an adjunction to, the AI example for modeling the anticipated or normal behavior. For relatively complex software, however, the AI example is typically a more practical approach.

In the operation mode, for every message received from the instrumentation 105, the supervisor 102 uses the imminent behavior (i.e., the instruction or event that is about to be executed by the supervised program 103) and the history, input data, and/or other parameters mentioned above to determine whether the imminent behavior falls within a behavior or range of behaviors encapsulated by the acceptable behavior model 104. The supervisor 102 does this by comparing the sequence of events (including the current or instant event and a sufficient number of preceding events), the input data, etc. with the normal sequence of events in the acceptable behavior model 104. Then the supervisor sends either an approval message or signal for operations to continue with the instant event or an alert message or signal to terminate, stop, or pause the executing of the supervised program 103 and/or to execute one or more program-specified or program-requested exception routines. In this manner, in some examples, the supervisor 102 in the operation mode monitors and approves the received messages or a subset of the messages. In some examples, the supervisor 102 monitors the information in the received messages without sending approvals (i.e., the instrumentation 105 assumes approval) but sends the termination signal/alert upon detecting that the instant event is possibly an abnormal or unanticipated behavior. As an example, the supervisor 102 generates and sends the termination signal/alert when the supervisor 102 detects that an unanticipated flow-control operation has been called such as might be the case with malicious or rogue code (e.g., the result of malicious intent) or an unanticipated error within the application code (error in programming, which could permit a security breach). In this manner, the detection system 100 can prevent abnormal or unanticipated behavior or prevent execution of a current action of the program, thereby providing program behavior enforcement.

Alternatively, in some examples, the supervisor 102 may represent a learning supervisor and a monitoring supervisor that are physically and/or logically separate from each other. In this case, instead of the supervisor 102 being able to run in both of the two modes, the learning supervisor runs in the model-building mode, and the monitoring supervisor runs in the operation mode.

### Summary of Model-Building Mode

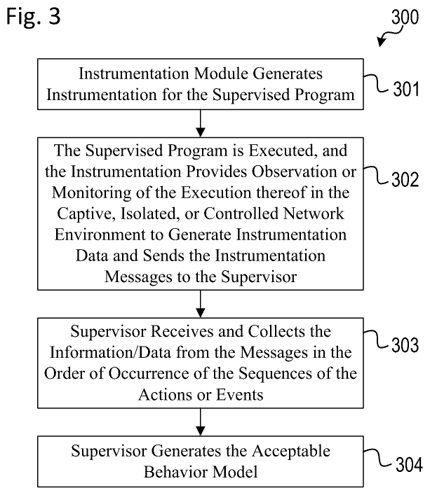

Operations of the instrumentation module 101 and the supervisor 102 during the model-building mode have been described above. FIG. 3 is a simplified flowchart of an example summary process 300 for generating the acceptable behavior model 104 in the model-building mode, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

At 301, the instrumentation module 101 generates the instrumentation 105 for the supervised program 103. For example, for the interpreted language example, the instrumentation module 101 is provided with a modified code interpreter that generates executable code with instrumentation extra code that can interrupt the normal interpretation of the supervised program 103 at appropriate tap or instrumentation points or locations that the modified code interpreter detects, or the instrumentation module 101 generates instrumented code for the supervised program 103 with which a conventional code interpreter generates such executable code. For the compiled language example, the instrumentation module 101 compiles or recompiles the supervised program 103 and inserts the instrumentation extra code into the existing code of the supervised program 103. For the hardware implementation example, the instrumentation module 101 includes an adjunct processor sub-system that monitors the main processor that executes the supervised program 103, which may have instrumented code.

At 302, the supervised program 103 is executed in the normal manner that programs are executed, but with the enhancements of the instrumentation 105 with which the instrumentation data is generated and communicated to the supervisor 102. During such execution, the instrumentation 105 observes or monitors the execution of the supervised program 103 in the captive, isolated, or controlled network environment (in accordance with normal or expected operation without malicious/unacceptable behavior, in the absence of external hostile influences, or with only expected, acceptable or non-malicious behavior) to generate instrumentation data (e.g., data indicative of the events). The instrumentation 105 then sends the instrumentation messages with the instrumentation data to the supervisor 102. In this manner, the instrumentation 105 generates a record of events including the sequences of events that occur during the normal operation of the supervised program 103. For example, for the interpreted language example, extra code in the executable code generated by the modified or conventional code interpreter generates the instrumentation data during normal execution of the supervised program 103 and sends messages of actions or events by the supervised program 103 to the supervisor 102. For the compiled language example, execution of the compiled code of the supervised program 103 results in execution of the instrumentation extra code, which sends messages of actions or events by the supervised program 103 to the supervisor 102. For the hardware implementation example, the adjunct processor sub-system detects appropriate instrumentation points or responds to instrumented code execution during the execution of the supervised program 103 by the main processor, gathers instrumentation data for the actions or events by the executing code, and provides it in the messages to the supervisor 102.

At 303, the supervisor 102 receives and collects the information/data from the messages in the order of occurrence of the sequences of the actions or events to thereby form such sequences. The supervisor 102 may also compress the data, consolidate repeated sequences, and/or otherwise prepare the data for input to generating the acceptable behavior model 104.

At 304, the supervisor 102 generates the acceptable behavior model 104 based on the collected information of the sequences of the actions or events (i.e., the record of events). This may be, for example, the training of the AI model, the generating of the statistical analysis model, or for another appropriate pattern detection technique. At this point, the acceptable behavior model 104 has been created and is ready for use in the operation mode. Afterwards, therefore, the supervisor 102 uses the acceptable behavior model 104 to monitor functions, actions, events, or sequences of events received in the instrumentation data to determine whether to allow continuation of operations of the supervised program 103, to pause, terminate or stop the executing of the supervised program 103, and/or to execute one or more program-specified or program-requested exception routines.

### Summary of Operation Mode

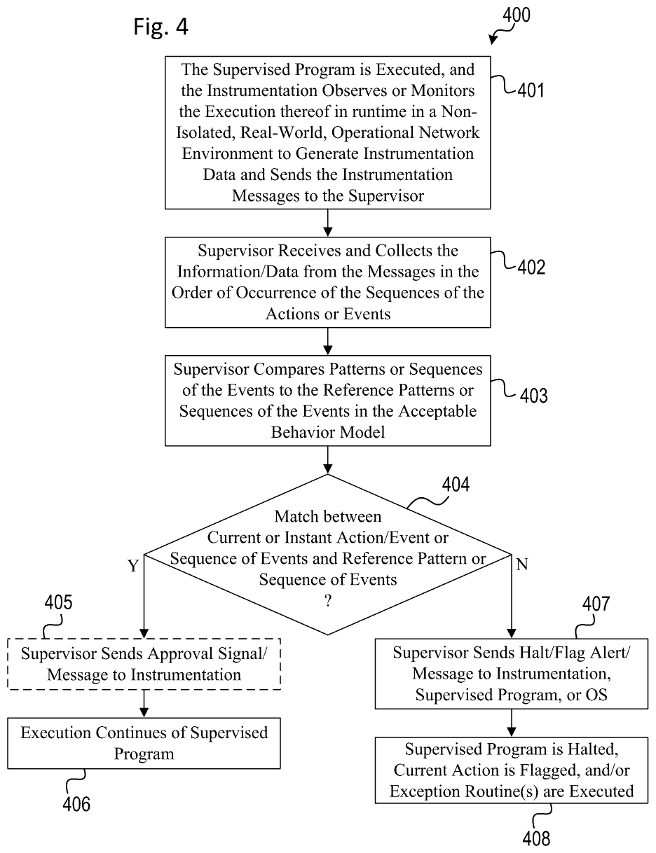

Operations of the instrumentation module 101 and the supervisor 102 during the operation mode have been described above. FIG. 4 is a simplified flowchart of an example summary process 400 for monitoring the supervised program 103 for abnormal behavior in light of the acceptable behavior model 104 in the operation mode, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

At 401, the supervised program 103 is executed in the normal manner that programs are executed. During such execution, the instrumentation 105 observes or monitors the execution of the supervised program 103 in runtime in a non-isolated, real-world, operational network environment (i.e., with or without unknown malicious behavior) to generate instrumentation data (e.g., data indicative of the events), as opposed to a test, simulated, captive, or isolated environment as used for development, testing, simulation, etc. The instrumentation 105 then sends the instrumentation messages with the instrumentation data to the supervisor 102. In other words, the instrumentation 105 detects or determines one or more actions or events (part of an operational sequence of events) of the supervised program 103 during execution of the supervised program 103 in the operation mode. In this manner, the instrumentation 105 generates a record of events for the sequences of events that occur in runtime during real-world operation of the supervised program 103, and the instrumentation 105 sends the record of events in the messages of actions or events by the supervised program 103 to the supervisor 102, during the operation mode in the same or similar manner as was performed at 302 during the model-building mode.

At 402, the supervisor 102 receives and collects the information/data from the messages in the order of occurrence of the sequences of the actions or events to thereby form such sequences (i.e., the operational sequence of events). The supervisor 102 may also compress the data, consolidate repeated sequences, and/or otherwise prepare the data as needed for input to the acceptable behavior model 104.

At 403, the supervisor 102 compares patterns or sequences of the events (i.e., operational events or operational sequences of events) to the reference patterns or sequences of the events in the acceptable behavior model 104. This may be done, for example, as inputs to the AI model, statistical analysis, or other appropriate pattern detection technique.

At 404, based on the comparison at 403, the supervisor 102 determines whether there is a match between the current or instant action/event or sequence of events (i.e., the operational events or operational sequences of events) and a reference pattern or sequence of events (i.e., in the acceptable behavior model 104) that is expected or known to occur during normal operation or behavior of the supervised program 103. This may be done, for example, as an output from the AI model, statistical analysis, or other appropriate pattern detection technique.

At 405, when the determination at 404 is positive/yes (i.e., there is a match), the supervisor 102 either does nothing or sends an approval signal/message (shown in dashed lines as being optional) to the instrumentation 105 or the supervised program 103 to continue operations. Thus, operation or execution of the supervised program 103 continues (at 406), including performing the current or instant action/event.

At 407, when the determination at 404 is negative/no (i.e., there is no match), the supervisor 102 sends a halt/termination/flag alert/message to the instrumentation 105, the supervised program 103, or the operating system to pause, terminate or stop the executing of the supervised program 103 or of the current thread thereof, to flag the current action, and/or to execute one or more program-specified or program-requested exception routines. Thus, operation or execution of the supervised program 103 is terminated, halted, or paused or the current action is flagged (at 408), and the supervised program 103 does not perform the current or instant action/event, in response to the halt/termination/flag alert/message. In some examples, the supervised program 103 executes the one or more program-specified or program-requested exception routines. For example, to terminate the supervised program 103 or thread thereof, the supervisor 102 terminates the supervised program 103 or thread directly, runs a termination procedure, or calls a termination handler.

Thus, in some examples, in the operation mode, the instrumentation 105 is continually sending messages with events to the supervisor 102, and the supervisor 102 is continually evaluating or analyzing the events or sequences of events and the watchdog thread timers 207 to determine whether to allow the supervised program 103 to continue executing normally or to terminate the supervised program 103.

### Sample Algorithms

The information or data in the messages sent by the instrumentation 105 to the supervisor 102 precisely identifies the location of the current or instant event, function, or line of code that is being or is about to be executed by the supervised program 103. Additionally, in some examples, the messages contain context information (e.g., thread ID, end user ID, etc.) that enable the supervisor 102 to discriminate between different logical execution flows. Such discrimination can be important because modern systems are usually non-sequential, i.e., handling multiple tasks or threads at the same time.

Within a given context (i.e., within a given execution thread), a sequence of messages from the instrumentation 105 describes the execution of the supervised program 103. This will be used to generate the acceptable behavior model 104 during the model-building mode. The algorithm for generating the acceptable behavior model 104 from the sequences of messages during the model-building mode generally depends on the algorithm for determining whether any sequence of events matches the acceptable behavior model 104 in the operation mode.

Options for this algorithm generally include at least two types of algorithms:
ML/AI based algorithms similar to the class of pattern recognition approaches that includes Large Language Models; and
Statistical analysis algorithms with a lookup structure of prefixes.

Both types of algorithms have different structures and characteristics. However, both are used to make the same determination of whether a current prefix belongs to the acceptable behavior model 104. In this context, “prefix” means the sequence of events that includes the current event and a limited sequence of events directly preceding the current event.

The ML/AI based approaches may result in the acceptable behavior model 104 being smaller and the performance of the monitoring by the supervisor 102 being faster. However, these advantages may come at the cost of more complex training and/or a higher number of false negatives (i.e., detecting no anomaly when one has occurred) and/or false positives (i.e., detecting an anomaly when one has not occurred).

The lookup structure produced from the statistical analysis algorithms may be simpler to construct and result in smaller number of false positives and false negatives. However, this may come at the potential cost of a larger model and bigger performance impact in monitoring during operation mode.

The above-described operation of the detection system 100 differs from conventional approaches that monitor for unusual “big picture” anomalies, such as unusual network traffic, CPU usage, memory access, file usage, data usage, etc. Such conventional approaches necessarily detect a security breach after it has already occurred, rather than provide a means to halt execution before the breach happens. Additionally, such conventional approaches typically assume knowledge of potential attack vectors, malware capabilities, or vulnerabilities; whereas, the detection system 100 has the advantage of not having to assume such knowledge, so the detection system 100 generates knowledge of normal acceptable behavior without regard to potential attack vectors in the code, malware capabilities, or vulnerabilities in the code.

### Supervisor Controls

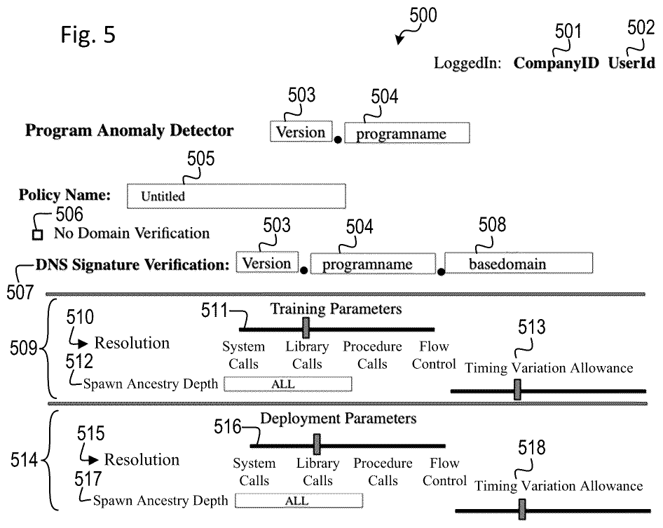

FIG. 5 is a simplified user input/control interface (UI) 500 for a user to input control parameters to the supervisor 102 for operating in the model-building mode and the operation mode, in accordance with some examples. The particular control parameters, combination of control parameters, and order of the control parameters for this data structure are provided for illustrative purposes only. Other examples could use different control parameters, combinations of control parameters, or orders of control parameters to achieve the same or similar result. The example UI 500 generally illustrates an example of a possible implementation of an API or user interface to permit clients, programmers, developers, or users (with appropriate training) to run the detection system 100 and to provide appropriate code-signing for assurance purposes. Other examples may include other types of controls or control parameters.

A company ID parameter 501 and user ID parameter 502 identify the developer (e.g., a person or entity) that is logged in to and is using the detection system 100. Each registered developer creates a master company ID for the company ID parameter 501. This is an internal item only and is never displayed in the signing of an application. Additionally, the user ID parameter 502 is unique to each registered developer.

The supervisor 102 (i.e., “program anomaly detector”) is provided with a version parameter 503 and a program name parameter 504. The version parameter 503 identifies the version of the supervised program 103 as set by the developer. The program name parameter 504 identifies the name of the supervised program 103 as also set by the developer and is unique to each developer.

A policy name parameter 505 (currently “Untitled”) is a name (internal to the developer) to enable the developer to identify or remember a particular set of rules or parameters that have been specified in the user input/control interface 500. Thus, the developer can have different sets of rules, each identified by a different policy name parameter 505, with which to experiment with different parameters for the model-building mode and the operation mode for the supervised program 103.

A “no domain verification” check box 506 is provided for the registered developer to select whether the program is verified and signed. If the check box 506 is selected, then the supervised program 103 is verified and signed using a domain that is internal to and controlled by an operator/owner of the detection system 100 to protect uniqueness of the domain.

If the check box 506 is not selected, then the supervised program 103 is verified and signed using DNS signature verification 507 with DNS records and a special server. The special server can be accessed via a URL formed with the version parameter 503 (filled in automatically as provided above), the program name parameter 504 (filled in automatically as provided above), and a verified base domain 508 that can be set only by the owner or manager of the base domain (typically the registered developer). In this manner, ownership or providence of the supervised program 103 is proven.

A training parameters section 509 is provided for setting parameters used during the model-building mode for generating the acceptable behavior model 104. For example, first resolution parameters 510 set the amount of data that the instrumentation module 101 creates the instrumentation 105 to generate and send, e.g., system calls, library calls, procedure calls, and/or flow control, among other types of data. In some examples, this is set by a training parameters (or “first”) slider bar 511 (shown as being set to the library calls).

For example, if system calls data is selected (e.g., when the training parameters slider bar 511 is set above “System Calls”), then data only for system calls will be generated and sent by the instrumentation 105 and used by the supervisor 102 in the model-building mode. This is the coarsest or least detailed granularity for the instrumentation, so the least amount of instrumentation data will be generated by this setting. If library calls data is selected (e.g., when the training parameters slider bar 511 is set above “Library Calls” as shown), then data for system calls and library calls will be generated and sent by the instrumentation 105 and used by the supervisor 102 in the model-building mode. If procedure calls data is selected (e.g., when the training parameters slider bar 511 is set above “Procedure Calls”), then data for system calls, library calls, and procedure calls will be generated and sent by the instrumentation 105 and used by the supervisor 102 in the model-building mode. If flow control data is selected (e.g., when the training parameters slider bar 511 is set above “Flow Control”), then data for system calls, library calls, procedure calls, and flow control will be generated and sent by the instrumentation 105 and used by the supervisor 102 in the model-building mode. This is the most fine-grained or most detailed granularity for the instrumentation, so the greatest amount of instrumentation data will be generated by this setting. (For implementations of the supervised program 103 in Java, “Class Calls” and “Method Calls”, or the equivalents in other program languages, may be used in place of “Library Calls” and “Procedure Calls”.) Alternatively, in some examples, check boxes (instead of the training parameters slider bar 511) can be used to individually select each of the first resolution parameters 510. On the other hand, in some examples, the supervisor 102 may be instructed (e.g., with another check box) that test cases are being used, in which case the supervisor 102 will use all data that can be generated.

Additionally, if the supervised program 103 spawns threads or additional processes, as is common with multi-threaded applications, a first spawn ancestry depth parameter 512 sets how many to monitor or a depth to which to monitor, so that the instrumentation module 101 can create the appropriate instrumentation 105 for these threads or processes. In some examples, this parameter is set to monitor “all” (as shown) spawned threads or processes, e.g., by default, or any other desired or appropriate depth. Furthermore, a first timing variation allowance parameter 513 may be used to set a resolution to record timing.

A deployment parameters section 514 is provided for setting parameters used when the detection system 100 is deployed during the operation mode, e.g., for the instrumentation 105 to generate operational events and operational sequences, and/or for the supervisor 102 to select which operational events and operational sequences to be monitored when using the acceptable behavior model 104 to determine whether any sequence of events matches the acceptable behavior model 104 and to determine whether to allow the supervised program 103 to continue executing normally or to terminate the supervised program 103. For example, second resolution parameters 515 set the amount of data that is to be generated and gathered by the instrumentation 105 and used by the supervisor 102, e.g., system calls, library calls, procedure calls, and/or flow control, among other types of data. In some examples, this is set by a deployment parameters (or “second”) slider bar 516 (shown as being set to the library calls). Alternatively, in some examples, check boxes (instead of the deployment parameters slider bar 516) can be used to individually select each of the resolution parameters 515.

In some examples, the second resolution parameters 515 are set by the deployment parameters slider bar 516 in a manner that is the same or similar to that of the first resolution parameters 510 and training parameters slider bar 511 in the training parameters section 509. Therefore, if the second resolution parameters 515 selected for the operation mode are the same as the first resolution parameters 510 selected for the model-building mode (i.e., if the deployment parameters slider bar 516 is set to the same resolution parameters as the training parameters slider bar 511), then the instrumentation 105 will generate and send and the supervisor 102 will collect and use in the operation mode the same types of data that were generated, sent, collected, and used in the model-building mode. However, if the second resolution parameters 515 selected for the operation mode are fewer than the first resolution parameters 510 selected for the model-building mode (i.e., if the deployment parameters slider bar 516 is set to fewer resolution parameters than that of the training parameters slider bar 511), then the instrumentation 105 will generate and send and the supervisor 102 will collect and use in the operation mode only the selected types of data (i.e., as indicated by the deployment parameters slider bar 516) and not any additional types of data that were generated, sent, collected, and used in the model-building mode. In other words, in this case, the operation mode will use a subset of the data that was used in the model-building mode. On the other hand, if the second resolution parameters 515 selected for the operation mode are more than the first resolution parameters 510 selected for the model-building mode (i.e., if the deployment parameters slider bar 516 is set to more resolution parameters than that of the training parameters slider bar 511), then this appears to indicate that additional data could be used in the operation mode that was not used in the model-building mode. However, in this case, the instrumentation 105 will generate and send and the supervisor 102 will collect and use in the operation mode only the same types of data that were generated, sent, collected, and used in the model-building mode. In other words, the acceptable behavior model 104 would not work with any additional data that was not used to generate it. Therefore, regardless of the selection of the second resolution parameters 515 (i.e., the setting of the deployment parameters slider bar 516), the detection system 100 will generate, send, collect, and use in the operation mode the type of data selected only if it was also generated, sent, collected, and used in the model-building mode.

Additionally, if the supervised program 103 spawns threads or additional processes, a second spawn ancestry depth parameter 517 sets how many to monitor or a depth to which to monitor. In some examples, this parameter is set to monitor “all” (as shown) spawned threads or processes, e.g., by default, or any other desired or appropriate depth. Furthermore, a second timing variation allowance parameter 518 may be used to set a resolution to record timing, which indicates how much slack is allowed in timing during runtime before the thread timers 207 indicate that there has not been an expected response within an expected amount of time.

### Modified Code Interpreter

For the supervised program 103 written in an interpreted or bytecode language (e.g., such as but not limited to PHP (recursive acronym for PHP: Hypertext Preprocessor), Ruby, Python, and JavaScript), there is no need to compile code. Instead, in some examples, a modified code interpreter (which includes the instrumentation module 101) generates the instrumentation 105 while it is interpreting the code to generate instrumented executable code for execution. In other examples, the instrumentation module 101 instruments the interpreted-language code, and a code interpreter generates instrumented executable code for execution. A conventional code interpreter, by comparison, may be used to execute, emulate or debug interpreted code. Conventional debugging, however, generally requires foreknowledge of types of vulnerabilities or potential attacks. The present invention, on the other hand, has the advantage of not requiring such knowledge.

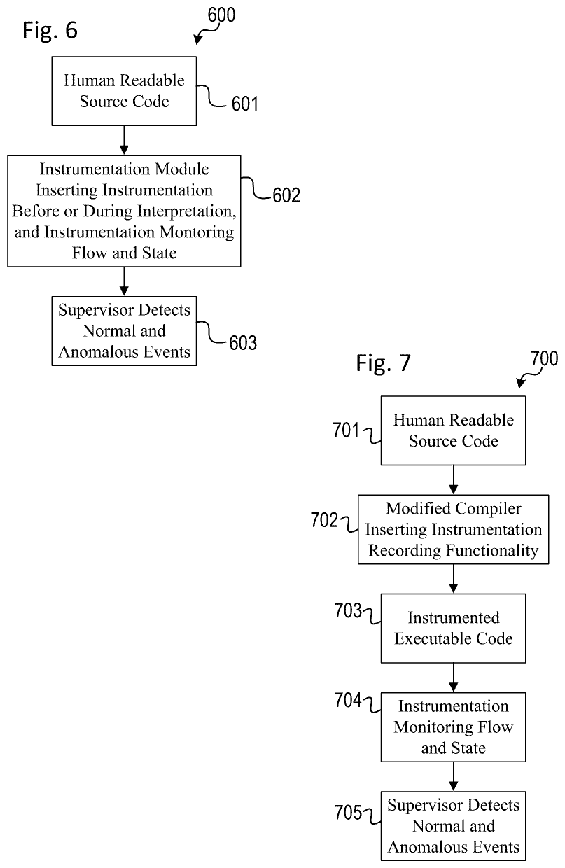

FIG. 6 is a simplified flowchart of an example summary process 600 for instrumenting and monitoring the supervised program 103 that includes interpreted-language code, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

The process 600 generally starts (at 601) with the human readable source code of the supervised program 103, which is a traditional way of writing instructions for program execution. At 602, the instrumentation module 101 inserts the instrumentation 105 before or during the interpretation, so the instrumentation 105 can monitor flow and state information. Therefore, in some examples, the modified code interpreter inserts instrumentation 105 during interpretation of the lines of code of the source code. In this manner, the modified code interpreter also monitors flow and state data. The modified code interpreter, therefore, is a separate program that not only interprets the code written for the supervised program 103 (as is usually done by a conventional code interpreter) but also monitors the instructions, actions or events of the code for appropriate instrumentation points. The modified code interpreter, thus, installs the necessary tap points on-the-fly during interpretation and execution to generate the instrumentation data needed to observe the execution of the supervised program 103. With each line of code, therefore, the modified code interpreter interprets the code and determines whether instrumentation data needs to be generated (and sent to the supervisor 102) for the current action or event before executing it. Alternatively, at 602, the instrumentation module 101 instruments the interpreted-language code, so that the code interpreter generates the executable code to include portions of executable instrumentation code (i.e., the instrumentation 105) and portions of executable regular code of the supervised program 103. Additionally, time durations for the watchdog thread timers 207 may also be determined at this point. Then the supervisor 102 detects (at 603) normal and anomalous events.

### Modified Compiler

In some examples, previously compiled code for a compiled-language supervised program 103 is recompiled (or code is compiled for the first time) by a modified compiler that incorporates the instrumentation module 101. The modified compiler uses the instrumentation module 101 to automatically add instrumentation instructions to the source code before generating the compiled executable code. (Additionally, in some examples for some compiled languages, operating system facilities may be used by the instrumentation 105 (e.g., ptrace available for the Linux operating system), or calls to shared libraries may be intercepted by the instrumentation 105.)

FIG. 7 is a simplified flowchart of an example summary process 700 for instrumenting and monitoring the supervised program 103 using a modified compiler, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

The process 700 generally starts (at 701) with the human readable source code of the supervised program 103. At 702, the modified compiler uses the instrumentation module 101 to insert instrumentation recording functionality and then compiles the source code to generate the executable code, which includes the instrumentation 105. Thus, in addition to creating a machine code interpretation of the human readable source code, the modified compiler adds the flow and state recording functionality to generate the instrumented executable code 703. The instrumented executable code 703 is run by a hardware processor in the manner that the developer or programmer would expect, while at same time sending state and flow information to the supervisor 102. At 704, the instrumentation 105 in the instrumented executable code 703 monitors the flow and state of the execution of the instrumented executable code 703. At 705, the supervisor 102 detects normal and anomalous events and flags flow anomalies and/or state anomalies.

### Hardware Implementation

A hardware implementation generally has the potential to be faster and more efficient than the software-only examples. In some hardware implementation examples, the instrumentation module 101 instruments the supervised program 103 similarly to, but not as extensively as in, the modified code interpreter or modified compiler examples, but the operation of the instrumentation 105 and the supervisor 102 is accelerated by a separate adjunct processor sub-system linked to a main processor system that is executing the supervised program 103. In some hardware implementation examples, the adjunct processor sub-system receives signals on all or a portion of the I/O pins of the main processor with which to determine the actions of the main processor as it is executing the supervised program 103 and then to determine the instrumentation data to be generated based on these actions. In the model-building mode and the operation mode, the adjunct processor sub-system gathers the instrumentation data from the (optionally instrumented) executing code of the supervised program 103, and provides it to the supervisor 102, which may be implemented in software.

In some examples, the adjunct processor sub-system is as tightly linked as possible to the main processor system. For example, the adjunct processor sub-system could be incorporated in custom integrated circuit (IC) chip (e.g., via a design portability schema such as HDL), a separate computing device, or a plug-in card with appropriate bus access. Additionally, in some examples, the adjunct processor sub-system uses a RAM/ROM and/or EEPROM or equivalent that is independent from that of the main processor system.

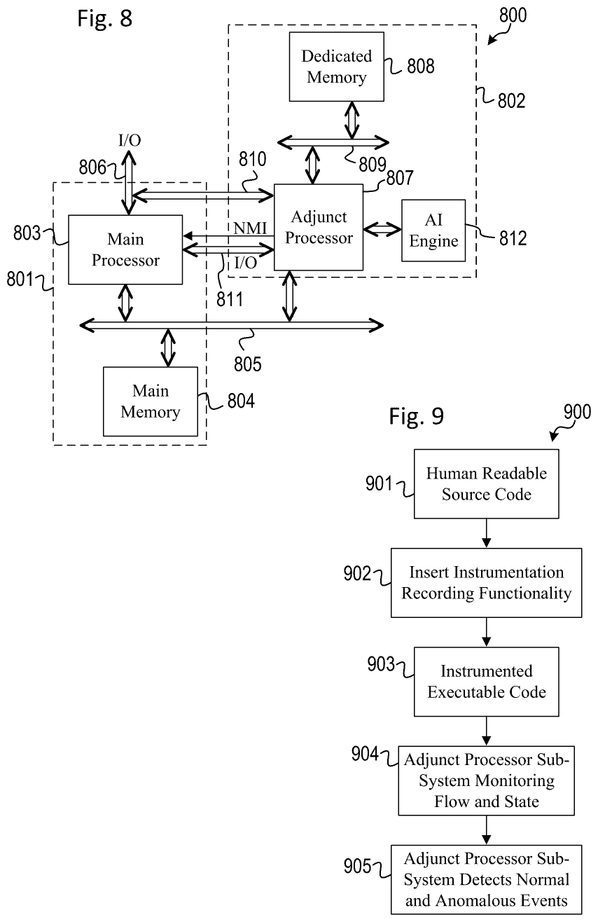

In some examples, at a high level, an example hardware implementation may comprise an adjunct processor sub-system, either collocated in the same IC chip or on the same printed circuit board (PCB) with the main processor system or located off-board in the form of a daughterboard attached (directly or indirectly) to the PCB of the main processor system or a separate computing device from that containing the main processor system. FIG. 8 is a simplified block diagram of a computing system 800 of an example hardware implementation having a main processor system 801 and an adjunct processor sub-system 802, in accordance with some examples.

The main processor system 801 generally includes a main processor (CPU) 803, a main memory 804, a communication bus 805, and an input/output (I/O) subsystem 806, among other appropriate components not shown for simplicity. The adjunct processor sub-system 802 generally includes an adjunct processor 807, a dedicated memory 808 (e.g., volatile and/or non-volatile), a dedicated communication bus 809, a first dedicated I/O bus 810 for communication with the I/O subsystem 806, a second dedicated I/O bus 811 for direct communication with the main processor 803, and an AI engine 812, among other appropriate components not shown for simplicity.

In some examples, the adjunct processor sub-system 802 executes the instrumentation module 101 and the supervisor 102. Thus, the hardware implementation of the detection system 100 is not dependent on the main processor system 801 for operating instructions, except for the optional instrumentation of the supervised program 103. In some hardware examples with instrumentation of the supervised program 103, the adjunct processor sub-system 802 monitors events that are flagged by the instrumentation 105. (The optional instrumentation in the supervised program 103 in combination with related operation of the adjunct processor 807, therefore, forms the instrumentation 105 of FIG. 1 in some of the hardware implementation examples for generating the instrumentation data for use by the supervisor 102.) The optional instrumentation helps to reduce the load on the adjunct processor 807 and increase the speed at which decisions can be made in the operation mode. Therefore, the adjunct processor 807 detects program flow control changes (i.e., instrumentation data) as indicated by the instrumentation running on the main processor system 801 and uses those inputs for the supervisor 102 to build the acceptable behavior model 104 in the model-building mode and to monitor the supervised program 103 in the operation mode. In some examples without the added optional instrumentation, the adjunct processor sub-system 802 may monitor every instruction executed by the main processor system 801, e.g., by snooping signals on the I/O pins thereof. Additionally, in some examples, the second dedicated I/O bus 811 is a dedicated I/O channel that enables the supervisor 102 to have access to the internal state, pipeline, and internal registers of the main processor 803 to monitor control signals and observe some actions of the supervised program 103, e.g., to detect when a branch is about to occur and determine whether it is normal or abnormal. Additionally, the AI engine 812 may be a separate hardware component (e.g., a co-processor) from the adjunct processor 807 or a software module running on the adjunct processor 807. The AI engine is used by the supervisor 102 to build the acceptable behavior model 104 in the model-building mode and to monitor the supervised program 103 in the operation mode. Additionally, the watchdog thread timers 207 are implemented in the adjunct processor 807.

The main processor system 801 and the adjunct processor sub-system 802 are both connected through the communication bus 805 to the main memory 804. The main memory 804 contains the supervised program 103 and provides the code through the communication bus 805 to the main processor 803 for execution thereof in the normal manner of a conventional computing system. The main memory 804 also provides the code of the supervised program 103 through the communication bus 805 to the adjunct processor 807 for monitoring thereof.

In the model-building mode and the operation mode, the adjunct processor sub-system 802 monitors the instrumented execution of the supervised program 103 by the main processor system 801. Thus, the monitored data received by the adjunct processor 807 includes the instructions of the compiled instrumented code of the supervised program 103 (via the communication bus 805), copies of memory accesses caused by the execution of the supervised program 103 (via the communication bus 805), copies of I/O accesses from the I/O subsystem 806 caused by the execution of the supervised program 103 (via the dedicated I/O bus 810), and control signals or instructions received through the second dedicated I/O bus 811. With this data, the instrumentation 105 (executing under operations of the adjunct processor 807) generates the instrumentation data and sends it to the supervisor 102 (also operating on the adjunct processor 807), which stores it (via the dedicated communication bus 809) in the dedicated memory 808.

In some examples, the adjunct processor sub-system 802 enters the model-building mode in response to a command received via a dedicated I/O port. In the model-building mode, the adjunct processor sub-system 802 (in accordance with operation of the instrumentation 105) monitors the instrumented execution of the supervised program 103 by the main processor system 801, preferably configured in an isolated captive environment in order that only valid operations can occur. Then, in some examples, the adjunct processor sub-system 802 (in accordance with operation of the supervisor 102) uses the instrumentation data stored in the dedicated memory 808 in the AI engine 812 to generate the acceptable behavior model 104. The acceptable behavior model 104 is stored by the supervisor 102 in the dedicated memory 808, rather than in the main memory 804.

Since a sub-system AI engine is used to process the instrumentation data generated by the instrumentation 105 and collected by the supervisor 102, this data can be processed faster and with greater confidence of low false-alarm rate (i.e., the false positives mentioned above) for a given range of test cases than would be possible with alternative training approaches. This process generates the acceptable behavior model 104, which may be refined and improved as the result of more information gathered during the operation mode. In some examples, the adjunct processor sub-system 802 is programmed to enable upload, via a secure interface, of operational metrics for the acceptable behavior model 104 derived from a physically separate captive isolated test-bed, thereby permitting rapid deployment of learned metrics to a number of such systems.

In the operation mode, the adjunct processor sub-system 802 similarly monitors the instrumented operation of the main processor system 801 as provided by the instrumentation 105. Thus, in the operation mode, the adjunct processor sub-system 802 (running the supervisor 102) takes each received input of instrumentation data, in particular but not limited to flow change operations, actions or events, and considers at each step whether such an operation matches “normal operation” using the acceptable behavior model 104, as described above. If the operation does not match the normal or anticipated operation or does not match the normal or anticipated range of operation per the acceptable behavior model 104, the adjunct processor sub-system 802 uses a non-maskable interrupt (NMI) and/or its I/O connection (e.g., via 806, 810, and/or 811) with the main processor system 801 to halt the operation, flag the operation as out of anticipated range, and/or execute one or more program-specified or program-requested exception routines. The non-maskable interrupt ensures that the halt cannot be defeated. Additionally, the second dedicated I/O bus 811 enables the supervisor 102 to provide interrupt instructions to the main processor 803 to take appropriate action upon receiving the NMI and halting the supervised program 103 or a thread thereof, so that potentially malicious code cannot take control of operations of the main processor 803.

Therefore, the hardware implementation is similar to the approaches described above in relation to the modified code interpreter implementation and the modified compiler implementation with the exceptions that: a) any load on the main processor system 801 is minimised; b) the model-building mode can be expected to go faster; and c) the detection system 100 will operate with a greater degree of integrity, since it is not reliant on the underlying operating system or application code of the main processor system 801. Additionally, as in all implementations, the generation of the acceptable behavior model 104 is performed in the absence of knowledge (or disclosure) of the code used in the supervised program 103, except for some examples that include certain instrumentation features in order to take advantage of the capabilities of the adjunct processor sub-system 802.

FIG. 9 is a simplified flowchart of an example summary process 900 for instrumenting and monitoring the supervised program 103 using a hardware implementation, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

The process 900 generally starts (at 901) with the human readable source code of the supervised program 103. At 902, in some examples, instrumentation recording functionality is inserted into the source code similar to step 702 for the modified compiler implementation above. Thus, the flow and state recording functionality is added to the compiled machine code interpretation of the human readable source code to generate (instrumented) executable code 903. In other examples, on the other hand, the executable code 903 does not include instrumentation, because the adjunct processor sub-system 802 is configured to handle the functions that generate the instrumentation data. The executable code 903 (whether instrumented or not) is run by the main processor system 801 in the manner that the developer or programmer would expect. At 904, the adjunct processor sub-system 802 (by executing the instrumentation 105) monitors the flow and state of the execution of the executable code 903. At 905, the adjunct processor sub-system 802 (by executing the supervisor 102) detects normal and anomalous events, flags flow anomalies and/or state anomalies, halts execution of the executable code 903, and/or executes one or more program-specified or program-requested exception routines.

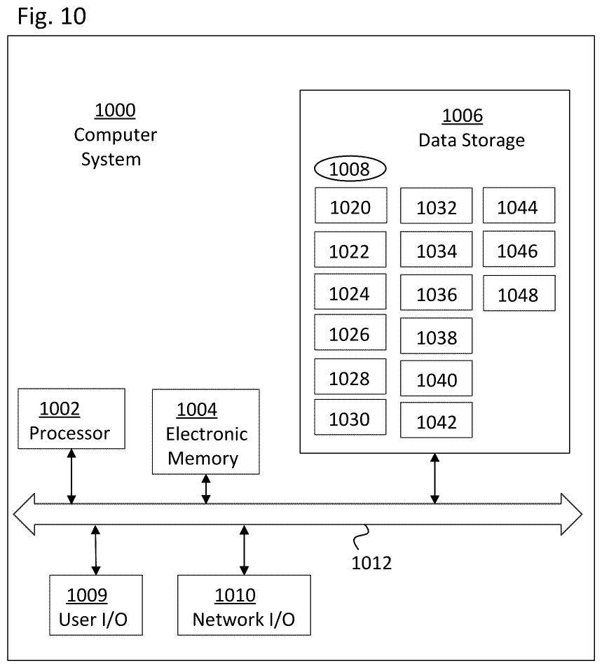

FIG. 10 is a simplified schematic diagram showing an example computer system 1000 (representing any combination of one or more of the computer systems) for use in the detection system 100 for executing any of the software programs described herein, in accordance with some examples. Other examples may use other components and combinations of components. For example, the computer system 1000 may represent one or more physical computer devices or servers, such as web servers, rack-mounted computers, network storage devices, desktop computers, laptop/notebook computers, etc., having one or more processors or one or more processor cores, depending on the complexity of the detection system 100. In some examples implemented at least partially in a cloud network potentially with data synchronized across multiple geolocations, the computer system 1000 may be referred to as one or more cloud servers. In some examples, the functions of the computer system 1000 are enabled in a single computer device. In more complex implementations, some of the functions of the computing system are distributed across multiple computer devices, whether within a single server farm facility or multiple physical locations, and whether implemented on computer systems having the same or dissimilar architectures or types of processors. Thus, where the claims recite a “computer system” or “computerized system”, it is understood that this may refer to any of these examples.

In some examples where the computer system 1000 represents multiple computer devices or systems, some of the functions of the computer system 1000 are implemented in some of the computer devices, while other functions are implemented in other computer devices. For example, various portions of the detection system 100 can be implemented on the same computer device or separate computer devices, regardless of whether the computer devices have the same or dissimilar architectures or types of processors.

In the illustrated example, the computer system 1000 generally includes at least one processor 1002, at least one main electronic memory 1004, at least one data storage 1006, at least one user I/O 1009, and at least one network I/O 1010, among other components not shown for simplicity, connected or coupled together by a data communication subsystem 1012.

The processor 1002 represents one or more central processing units, computer processors, co-processors, processor cores, or clusters of processors, in one or more IC chips, on one or more PCBs (printed circuit boards), and/or in one or more housings or enclosures. In some examples, the processor 1002 represents multiple microprocessor units in multiple computer devices at multiple physical locations interconnected by one or more data channels. Thus, where the claims recite a “processor”, it is understood that this may refer to any of these examples. Additionally, when executing computer-executable instructions for performing the above-described functions of the computer system 1000 (i.e., the detection system 100) in cooperation with the main electronic memory 1004, the processor 1002 becomes a special purpose computer for performing the functions of the instructions.

The main electronic memory 1004 represents one or more RAM modules on one or more PCBs in one or more housings or enclosures. In some examples, the main electronic memory 1004 represents multiple memory module units in multiple computer devices at multiple physical locations. In operation with the processor 1002, the main electronic memory 1004 stores the computer-executable instructions executed by, and data processed or generated by, the processor 1002 to perform the above-described functions of the computer system 1000 (i.e., the detection system 100).

The data storage 1006 represents or comprises any appropriate number or combination of internal or external physical mass storage devices, such as hard drives, optical drives, network-attached storage (NAS) devices, flash drives, etc. In some examples, the data storage 1006 represents multiple mass storage devices in multiple computer devices at multiple physical locations. The data storage 1006 generally provides persistent storage (e.g., in a non-transitory computer-readable or machine-readable medium 1008) for the programs (e.g., computer-executable instructions) and data used in operation of the processor 1002 and the main electronic memory 1004. The non-transitory computer readable medium 1008 includes instructions (e.g., the programs and data 1020-1048) that, when executed by the processor 1002, cause the processor 1002 to perform operations including the above-described functions of the computer system 1000 (i.e., the detection system 100).

In some examples, the main electronic memory 1004 and the data storage 1006 include all, or a portion of the programs and data (e.g., represented by 1020-1048) required by the processor 1002 to perform the methods, processes and functions disclosed herein (e.g., in FIGS. 1-9), e.g., including the functions of the model-building mode and the operation mode. Under control of these programs and using this data, the processor 1002, in cooperation with the main electronic memory 1004, performs the above-described functions for the computer system 1000 (i.e., the detection system 100).

The user I/O 1009 represents one or more appropriate user interface devices, such as keyboards, pointing devices, displays, etc. In some examples, the user V/O 1009 represents multiple user interface devices for multiple computer devices at multiple physical locations. A system administrator, for example, may use these devices to access, set up, and control the computer system 1000.

The network I/O 1010 represents any appropriate networking devices, such as network adapters, etc. for communicating throughout the detection system 100. In some examples, the network I/O 1010 represents multiple such networking devices for multiple computer devices at multiple physical locations for communicating through multiple data channels.

The data communication subsystem 1012 represents any appropriate communication hardware for connecting the other components in a single unit or in a distributed manner on one or more PCBs, within one or more housings or enclosures, within one or more rack assemblies, within one or more geographical locations, etc.

Instrumentation with Stacktrace

There is a tradeoff between instrumentation (i.e., how much detail is obtained by the instrumentation) and program performance (i.e., how efficiently it runs). This is because every instrumentation point that is injected into the program and the monitoring actions that are then performed potentially degrade the performance of the program, because the actions of the instrumentation and monitoring have to be performed in addition to the actions of the existing code of the supervised program. Additionally, a relatively large number of instrumentation points might make the acceptable behavior model too sensitive, which could require a longer training process ensure that false positives are avoided or mitigated.

To minimize the performance and training impact of instrumentation, in some cases, the systems and methods herein primarily (but not exclusively) focus on instrumenting kernel calls (i.e., SYSCALLs and their equivalent in VM based programs). This level of instrumentation is generally considered sufficient, because permanent changes typically cannot be done to the computer system by the supervised program without a call to the kernel. Thus, this approach does not significantly limit the expressive power of the systems and methods herein.

A SYSCALL is an instruction that a user level program (e.g., the supervised program 103) can use to interact with the kernel of the operating system to perform low level operations that the user level program is not allowed to do. Operations then transition to the kernel (in privilege mode) to handle the SYSCALL to perform the low level operation, such as hardware interactions, memory reads/writes, network accesses, program spawns, etc. It is with such operations that malicious activity can typically occur, so it is desirable for the detection system 100 to analyze the performance of the supervised program 103 at these points. Therefore, in some cases, since it is the SYSCALLs that instigate these operations, it is the SYSCALLs that the detection system 100 is primarily tasked with flagging or intercepting to perform the instrumentation for comparison with the acceptable behavior model to verify that the current operation is acceptable.

In addition to observing or determining that execution of the supervised program has reached an instrumentation point, the systems and methods herein also collect context data, which is discussed above with respect to the history or context of execution (i.e., the sequence of events which the supervised program 103 executed before the current point of execution). Part of the context data can include the stacktrace (i.e., the chain of function calls leading to the instrumentation point). The chain of function calls provides or enables indirect information about the behavior of the supervised program before the execution has reached the instrumentation point, but without a performance impact that would occur if each of these function calls were to be individually instrumented. The use of the stacktrace to obtain or generate the sequence of events of SYSCALLs (in both the model-building mode and the operation mode) has been determined to be a particularly efficient and desirable approach. Thus, the operational sequence can be constructed from stacktraces and call parameters at SYSCALL points, as described herein.

In addition to including the stacktrace in the context data, the systems and methods herein can collect call parameters at the instrumentation point. The call parameters enable the systems and methods herein to react to a situation where valid or acceptable behavior might be hijacked for malicious purposes (e.g., in the case of SQL injections or an attempt to open a file that had never been accessed before, among other situations).

In some cases, this usage of the stacktrace to provide the context data is part of the instrumentation resolution described above with respect to the training parameters section 509 and deployment parameters section 514 shown in FIG. 5. In other words, the stacktrace can be used to obtain the desired level of instrumentation data as set by the training parameters slider bar 511 and/or the deployment parameters slider bar 516, as described above.

In some cases, an application programming interface (API) can be used to obtain extra metadata for the supervised program 103 that may be difficult to infer from the instrumentation point alone (e.g., expected user id, flow id, http headers, special variables/internal classes, etc.) which will enable the systems and methods herein to augment the context data obtained from the stacktrace. This augmented context allows the systems and methods herein to create a higher-level model of application behavior (thus more efficient) that allows addressing attacks (e.g., privileged escalation, among others) in an efficient manner.

In some cases, the stack unwind feature can be used to obtain instrumentation data, such as system calls. Stack unwind is a process to obtain a previous sequence of calls and parameters starting from a given point of examination. Conventionally, stack unwind has been used for the purposes of program debugging and exception routines. For the systems and methods herein, however, stack unwind can be used to identify system calls, which can be used as an efficient subset of the program flow control in developing the model in the model-building mode and then monitoring the behavior of the supervised program in the operation mode. Thus, stack unwind can be used as an efficient filtering mechanism for program flow.

A potential drawback to the use of stack unwind is that stack unwind may miss some calls (e.g., less critical internal calls) that have returned prior to the current point of program execution. For example, in a function calling sequence of A→B→C→D, function D returns and function C continues to a SYSCALL-S. Doing a stack unwind at the point of SYSCALL-S, however, will leave no trace of function D being called. This is a filtering that is built into stack unwind.

The use of the system calls as a filtering mechanism or a sufficient approximation for the program flow control used by detection system 100 is an efficient technique that decreases overhead, i.e., the impact of detection system 100 on program execution time. This is because it is reasonable to assume that, in the vast majority of cases, an unacceptable action by the supervised program 103 or malicious code can do damage only by doing a system call. This assumption enables the systems and methods herein to stop most attacks with minimal impact on the performance of the supervised program. Thus, the stack unwind is used as a fast form of filtering the program flow which increases the performance of the detection system 100. Additionally, the sequence of system calls, as well as the parameters used, can then be used as an efficient way of enforcing program behavior with relatively low overhead. The following is an example of a pseudo code section showing the code that would result in such filtering (and loss of the knowledge of function D being called prior to the system call SYSCALL-S):
function D (paramlistD) {
. . . .
}
function C (paramlistC) {
D(paramlistD);
SYSCALL-S
}
function B (paramlistB) {
. . . .
C(paramlistC)
}
function A {
. . . .
B(paramlist)
. . .
}
main(paramlistMain) {
. . . .
A (paramlistA);
. . .
}

Although such filtering using the stack unwind may cause more detailed instrumentation data for program flow to be obtained, the impact on the performance of the supervised program is far less than would be caused by instrumenting each instruction.

### Variable Instrumentation Granularity

In some cases, different sections of the supervised program may have different instrumentation granularity requirements. In other words, the level of detail in the obtained instrumentation data may be different for different sections of the supervised program. This feature enables a higher instrumentation precision in some program sections of the supervised program and a lower instrumentation precision in other program sections. For example, it may be necessary to obtain high level flow control instrumentation data for one section of the supervised program but sufficient merely to obtain system calls for another section. In some cases, some sections of the supervised program might be considered to be more critical or might be at greater risk of malicious attack than other sections. Therefore, in some cases, the critical program sections could be instrumented at a more detailed level of granularity than the other sections. For example, some procedures that can be called only by an administrator might be more critical, so the more detailed instrumentation (e.g., “Flow Control” at 511 and 516) might be warranted for these sections. In this manner, acceptable-behavior enforcement can be done at different levels of granularity. In other words, depending on the context of the program section, the systems and methods herein can enforce acceptable behavior using more or fewer instrumentation points, thereby providing a tradeoff between program performance and security in which some contexts might suggest prioritizing detailed behavior enforcement (with more instrumentation points) over program performance and other contexts might suggest prioritizing program performance (with fewer instrumentation points) over detailed behavior enforcement. In some cases, the instrumentation granularity configuration options can be left to the discretion of the developer of the supervised program or the user of the detection system 100, because the developer/user is likely to know which sections of the supervised program are more critical or more vulnerable than other sections.

The greater instrumentation detail is obtained at the cost of slowing down program performance. If the context of a section of the supervised program justifies the need for more instrumentation data (e.g., a highly vulnerable or attack-prone section of code), then it might be acceptable to slow the performance of that section in order to obtain more instrumentation data. On the other hand, if the context of another section of the supervised program does not call for a large amount of instrumentation data, then a lower level or granularity of instrumentation will allow that section to run faster.

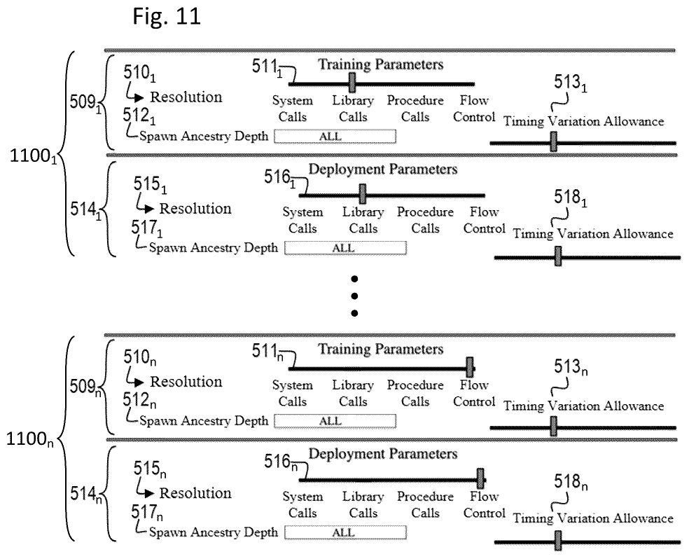

FIG. 11 shows an alternative implementation of a portion of the simplified user input/control interface shown in FIG. 5, in accordance with some examples. In the above description, the instrumentation resolution was set for the whole supervised program. However, in this implementation, parameter sections 1100₁-1100ₙ are provided for n sections or types of sections (e.g., Java classes, Java servlets, C#classes, modules, namespaces, packages, DLLs, shared objects, microservices endpoints, etc.) of the supervised program 103. In this manner, different sections or types of sections of the supervised program 103 can be instrumented with different levels of detail or resolution granularity. Thus, for the first parameter section 1100₁ for a first section or type of section of the supervised program 103, a first training parameters section 509₁ includes first training resolution parameters 510₁ with a first training parameters slider bar 511₁ (e.g., like the training parameters slider bar 511 described above), and a first deployment parameters section 5141 includes first deployment resolution parameters 5151 with a first deployment parameters slider bar 516₁ (e.g., like the deployment parameters slider bar 516 described above). Similarly, for the nth (or second) parameter section 1100ₙ for an nth (or second) section or type of section of the supervised program 103, an nth (or second) training parameters section 509ₙ includes nth (or second) training resolution parameters 510, with an nth (or second) training parameters slider bar 511ₙ (e.g., like the training parameters slider bar 511 described above), and an nth (or second) deployment parameters section 514ₙ includes nth (or second) deployment resolution parameters 515ₙ with an nth (or second) deployment parameters slider bar 516ₙ.

Thus, with separate parameter sections 1100₁-1100ₙ for different sections or types of sections of the supervised program 103, the resolution (or the amount of data) that the instrumentation module 101 uses to create the instrumentation 105 can be set differently as required or desired for each section or type of section. For example, when the supervised program 103 accesses a database via a database connection with database drivers, then a first level of granularity might be required or desired. On the other hand, when the supervised program 103 performs network accesses via a network connection with network drivers, then a second level of granularity might be required or desired.

In the example shown, the resolution for the training parameters for the first section or type of section of the supervised program 103 is set to “Library Calls” (as indicated by the first training parameters slider bar 511₁ being set above “Library Calls” as shown). Accordingly, the resolution for the deployment parameters for the first section or type of section is also set to “Library Calls” (as indicated by the first deployment parameters slider bar 516₁ being set above “Library Calls” as shown). On the other hand, the resolution for the training parameters for the nth (or second) section or type of section is set to “Flow Control” (as indicated by the nth (or second) training parameters slider bar 511ₙ being set above “Flow Control” as shown). Additionally, the resolution for the deployment parameters for the nth (or second) section or type of section is also set to “Flow Control” (as indicated by the nth (or second) deployment parameters slider bar 516, being set above “Flow Control” as shown).

In this manner, the record of events (generated at 302 in FIG. 3) can include a plurality of training sequences of events that occur during the normal, acceptable or expected operation of the supervised program in the model-building mode. A first training sequence of events of the plurality of training sequences of events can be obtained at a first level of detail from a first program section of a plurality of program sections of the supervised program. A second training sequence of events of the plurality of training sequences of events can be obtained at a second level of detail from a second program section of the plurality of program sections. The second level of detail can be greater than the first level of detail. Additionally, a third training sequence of events of the plurality of training sequences of events can be obtained at a third level of detail from a third program section of the plurality of program sections, wherein the third level of detail can be greater than the first and second levels of detail. Then in the operation mode, a first operational sequence of events of the supervised program can be determined or obtained (at 401 in FIG. 4) during execution of the supervised program in runtime during real-world operation of the supervised program. The first operational sequence of events can include a first current action. The first operational sequence of events can be obtained at the same first level of detail from the first program section. This can be used to perform the comparison to determine whether to perform the first current action. Similarly, a second operational sequence of events of the supervised program can be determined or obtained during execution of the supervised program in the operation mode. The second operational sequence of events can include a second current action. The second operational sequence of events can be obtained at the same second level of detail from the second program section. Alternatively, in some cases, the acceptable behavior model can be generated in the model-building mode using a highest, maximum or “training” level of instrumentation detail or granularity (i.e., each training sequence of events can be obtained at the maximum level of instrumentation detail), and then the instrumentation used for each program section during the operation mode can be at the same or a lower granularity level as that used in the model-building mode (i.e., each operational sequence of events can be obtained at one of the levels of instrumentation detail, with each level of instrumentation detail being different from other levels of instrumentation detail used in the operation mode but not higher than the training level of instrumentation detail). Or, more generally, the acceptable behavior model can be generated in the model-building mode using a level of instrumentation detail for a given program section, and then the instrumentation used for that program section during the operation mode can be at the same level of instrumentation, or a lower granularity level, as that used during the model-building mode. The potential for a difference between the instrumentation levels used in the model-building mode and the operation mode can be accounted for by skipping some of the events in the acceptable behavior model when doing the compare at 403 (FIG. 4) and the determination of the match at 404. In such cases, for example, the instrumentation level during the operation mode can depend on the CPU bandwidth or speed of the computer on which the supervised program is being run, i.e., a higher level of instrumentation can be used with a computer that has a higher CPU bandwidth, and vice versa.

In some cases, the spawn ancestry depth parameters 512₁-512ₙ and 517₁-517ₙ and the timing variation allowance parameters 513₁-513ₙ and 518₁-518ₙ can also be set differently for different sections or types of sections of the supervised program. These parameters can be set for each program section depending on the criticality or vulnerability of the program section, as described above for the instrumentation granularity. Alternatively, a single global setting can be used for either of these parameters for the entire supervised program.

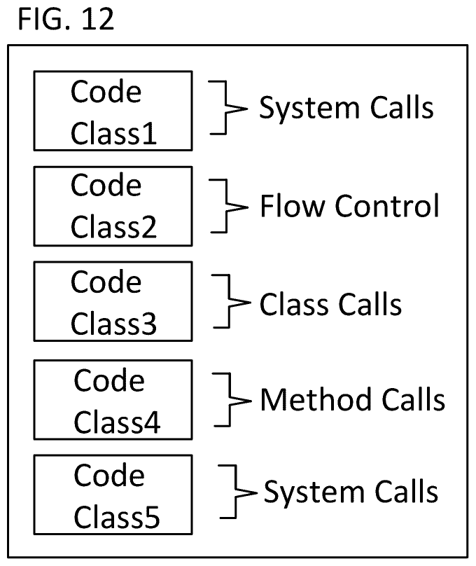

FIG. 12 is an illustration of how different sections or types of sections could have different instrumentation granularity requirements, in accordance with some examples. The illustrated example is an implementation for a Java program having five Java code classes (i.e., types of program sections) in which the instrumentation for the supervised program 103 will flag only system calls for program sections of a first Java code class 1 and a fifth Java code class 5, complete flow control instrumentation for program sections of a second Java code class 2, Java class calls for program sections of a third Java code class 3, and Java method calls for program sections of a fourth Java code class 4. (Similar examples can be made for other program languages that use classes or an equivalent thereof, e.g., C#, etc.). The settings of the training parameters slider bars 511₁-511n can be used to set these instrumentation levels for these types of program sections. Setting or changing the instrumentation granularity for any of the Java code classes will set or change it for every section of the supervised program that is of that class.

### Software Supply Chain Security

Software is often updated to a newer version that fixes bugs, errors, problems, or security issues in the existing or previous version of the software without changing the functionality of the software. In such cases, the detection system 100 can be used to identify unexpected changes in the supervised program between versions or to quickly detect whether the new version introduces new problems in the supervised program 103. Such problems could be due to a security risk in the software supply chain for the supervised program 103, e.g., wherein a component in the software supply chain of the supervised program 103 has or causes a different security risk profile in the new version compared to that of the previous version. (Alternatively, such problems could be due to a change in the supervised program itself, instead of in the software supply chain.)

A software supply chain is the components, libraries, tools, and processes used to develop, build, and publish a software artifact. The software supply chain represents the intricate network of processes, tools, and stakeholders involved in the development, distribution, and deployment of software applications. It encompasses the entire lifecycle of software, from conceptualization and coding to testing, packaging, and delivery to end-users. Akin to a traditional manufacturing supply chain, the software supply chain involves multiple interconnected stages and components that work together to produce the final product. The software supply chain, thus, includes a software bill of materials that declares the inventory of components used to build the software artifact, including any open-source and proprietary software components. It is the software analogue to the traditional manufacturing bill of materials (BOM), which is used as part of supply chain management in traditional manufacturing. In some cases, a security risk can be introduced into the new version of the supervised program due to a difference in function of a component of the software supply chain from the previous version of the supervised program to the new version thereof.

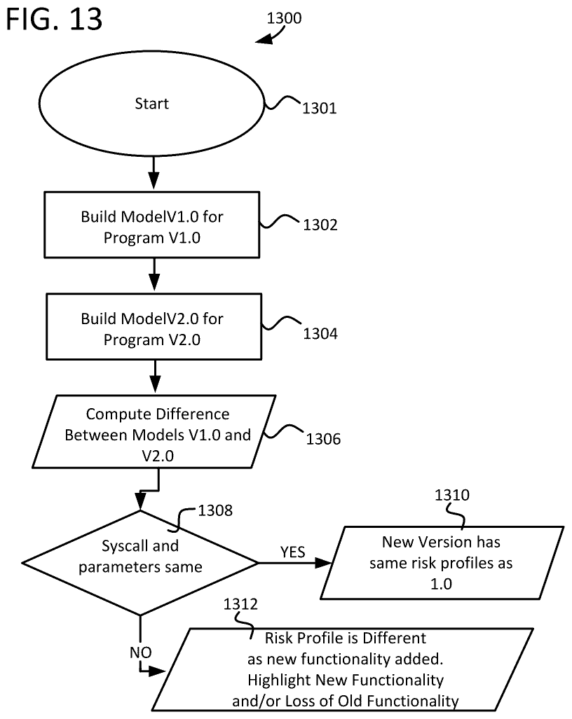

FIG. 13 is a simplified flowchart of a process 1300 (e.g., part of the programs and data 1020-1048 in FIG. 10) for determining whether the new version introduces new problems, security risks, or different behaviors in the supervised program 103, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps. In addition, some of the functions (or alternatives for these functions) of the process have been described elsewhere herein.

In some cases, upon starting (at 1301), the previous or first version of the supervised program 103 (e.g., Program V1.0) will have already been processed through the detection system 100 in the model-building mode to generate or build (at 1302) a first acceptable behavior model (e.g., Model V1.0). (If not, however, then the first version can be processed at this time to generate the first acceptable behavior model.) Then the new or second version of the supervised program 103 (e.g., Program V2.0) is also processed through the detection system 100 in the model-building mode to generate or build (at 1304) a second acceptable behavior model (e.g., Model V2.0) using the same test cases and operating in the same captive environment with the same captive normal operation as were used when building the first acceptable behavior model. In this case, the second acceptable behavior model can be referred to as simply a “behavior model” or “second behavior model”, because it might be unknown whether it contains unacceptable or malicious actions, events or behaviors (or contains only acceptable behavior). Therefore, for consistency, the first acceptable behavior model can be referred to as simply a first behavior model.

The second behavior model is then compared to the first behavior model to determine or compute (at 1306) any differences between the two behavior models, which might indicate that the first or second version of the supervised program performs one or more events or sequences of the events that are different from the operations of the other version (e.g., the second version of the program performs an event or a sequence of events that the first version of the program does not perform or the first version of the program performs an event or a sequence of events that the second version of the program does not perform). At 1308, for example, the process 1300 determines whether the events or sequences of events (e.g., the SYSCALLs and parameters and the context thereof) are the same or different between the two behavior models. If the events or sequences of events (e.g., the SYSCALLs and parameters) are the same, then the process 1300 returns (at 1310) an indication that the second version of the supervised program 103 has the same risk profile as that of the first version.

Any differences between the two behavior models, on the other hand, can reveal any new or different behaviors (e.g., added new events or sequences of events or removed previously existing events or sequences of events) of the second version of the supervised program 103. Such new or different behaviors might indicate new security threats or risks that have been intentionally or unintentionally introduced by the update. Therefore, if any of the SYSCALLs and/or parameters (i.e., within the context of the sequence of events which the supervised program 103 executed before the current SYSCALL) are found not to be the same at 1308, then the process 1300 returns (at 1312) an indication that the second version of the supervised program 103 has a different risk profile than that of the first version due to the new functionality that has been added to the second version. (In some cases, the difference in functionality, or the difference in the security risk profile, between the risk profile of the first version of the supervised program and the risk profile of the second version can be due to a change in function of a component of the software supply chain of both the first and second versions.) Additionally, the process 1300 highlights or flags the new functionality in the second version and/or the loss of old functionality from the first version to be analyzed for any security risk. Furthermore, in response to the second version of the program having a different risk profile than that of the first version of the program, the process 1300 might trigger or cause a security review of, cause modifications to be made to, or stop the deployment of, the second version of the supervised program.

(In some cases, if there is new intended functionality of the supervised program or new test cases are identified, then after performing process 1300 to detect unexpected functionality in comparison with the first behavior model, the test cases for the model-building mode will need to be augmented to build a new behavior model for use in the operation mode for the second version of the supervised program. The process 1300, however, is performed before the second version is run in the operation mode as a security check prior to operational release of the updated supervised program.)

A “model explainer” module (e.g., part of the model-building mode of the programs and data 1020-1048 in FIG. 10) can process a behavior model (i.e., an AI model) to generate or obtain a summary (e.g., which may be a natural-language human-readable summary to support a user's decision in some cases and a machine readable summary in other cases for use in automating the flagging of potential security issues, e.g., by an AI) of the observed behavior of the supervised program. The model explainer module extracts information from the behavior model that indicates the kind of model it is or that completely explains or describes the expected behavior of the supervised program. Thus, the behavior summary provides low level information about actions of the supervised program (that would not be available from just running test cases), such as which files were accessed for reads or writes, what network connections were opened or performed, what programs are spawned, which SQL calls were performed, or which other system calls, programs, functions or routines are executed, etc. Such summaries greatly simplify the establishment of risk profiles of the supervised program. Thus, whereas a typical purpose of the model explainer is to support users or developers in establishing a risk profile of a program, the model explainer module can also be used at step 1308 to determine whether the events or sequences of events (e.g., the SYSCALLs and parameters) are the same or different between the two behavior models.

For example, if the supervised program uses external libraries (i.e., part of the software supply chain), and one of the libraries in the second version of the supervised program performs actions (e.g., reads and writes) on a lot of files in the data storage 1006 that were not performed with the first version of the supervised program, then there is potentially a significant security issue with the second version. These actions will, therefore, be highlighted or flagged by the process 1300 as new functionality in the second version to be analyzed for any security risk.

In another example, if a software patch is added to any of the software in the supply chain, a supply chain attack could be included in the patch. In this manner, the detection system 100 helps ensure software supply chain security by detecting new actions or functions by program components obtained through the software supply chain even if the supervised program itself has not been changed.

In another example, the software supply chain may include functionality from third parties, such as open-source code. The supply chain may be compromised, however, if another party modifies the open-source code between the completion of the two versions of the supervised program to include potentially undesirable functionality. In this case, the differences between the first behavior model and the second behavior model would show the second version of the supervised program performing substantially different actions.

Because the behavior models are snapshots in time, with expected inputs, a comparison between the models will not detect unexpected functionality that does not manifest on start-up or initial execution of the supervised program or that can manifest only much later. Thus, if there is a supply chain vulnerability or other vulnerability in the supervised program itself that does not manifest on startup (e.g., a “time bomb” attack that is not caused to execute at the time of generating the behavior model), a comparison of the first and second behavior models generated in the model-building mode will not find it. However, such problems can be addressed by the operation mode, which runs during deployment of the supervised program. By using the operation mode, the detection system 100 is able to prevent (i.e., by detection prior to the execution of the code that has been added) a vulnerability in the supply chain or in the supervised program itself that does not manifest on startup, e.g., a “time bomb” that is intended to manifest some time, potentially months or years, after startup.

### Time Bomb Attacks

In some cases, the detection system 100 helps prevent “time bomb” attacks. A time bomb in software is a way to launch malicious software (i.e., a delayed event) activated under certain time conditions, such as malware with delayed execution that is run only when it detects that certain conditions have been met (e.g., a time period has passed or expired). A hidden backdoor in the software, for example, may go unnoticed for many years until it is activated or accessed. When the supervised program 103 is run in operation mode, however, it would not be susceptible to security risks of these types, because the detection system 100 would detect (before the delayed event is executed) any attempt to execute a delayed event as an anomalous event and prevent it from executing (e.g., by stopping execution of the supervised program). This is because the delayed execution of the delayed event would not have occurred during the model-building mode (so it will not have been included or represented in the acceptable behavior model) due to the certain condition not having been met at that time. Thus, when the delayed event occurs in the operation mode, it will necessarily represent an anomalous event. The detection system 100 is, thus, ideal for detecting and preventing the execution of time bomb attacks.

### Remote Code Execution Attacks

An example of a type of situation in which the detection system 100 is significantly useful is in the case of a remote code execution (RCE) attack. An RCE attack is an example of a type of attack in which new code is essentially remotely injected or added into the program while the program is running. Thus, RCE is a type of security vulnerability that allows an attacker to cause an event that attempts to execute malicious code on a target machine from a remote location. The actions that such remote code could perform are potentially unlimited, so the potential harm that can be done could be highly significant. Consequently, RCE attacks are very common and potentially very destructive. However, for detection system 100, these attacks are relatively easy to detect and prevent.

By the nature of RCE, new code is injected into the supervised program and executed. However, such new code will obviously not have been in the supervised program during the model-building mode, so the behavior of the new code will not have been captured by the acceptable behavior model. Therefore, any actions by the new code will immediately be detected by detection system 100 as an anomalous event. For example, between a first and a second version of the supervised program, if the first version of the supervised program did not perform the specific remote code execution, then any such execution by the second version will necessarily be different from the execution of the first version. Therefore, the comparison with the acceptable behavior model during the operation mode (e.g., at 403/404 in FIG. 4) will flag the current action (e.g., at 407/408) as an anomalous event.

In some examples, in specific cases of VM based languages (e.g., Java, C#, JavaScript, etc.), a common vector of attack is deserialization, which can potentially allow denial-of-service, access control, and RCE attacks. This problem, however, is solved with detection system 100 and with little or no performance impact on the supervised program. For example, when new code appears in a Java program (or other language having classes or an equivalent thereof), it goes to Class Loading (or an equivalent stage), which is one of the processes that is triggered only for loading new code. The detection system 100 intercepts this process and performs extra checks that verify whether the loaded new code is in the acceptable behavior model. Since such an instrumentation point is only triggered during code loading, there is no performance impact on execution of the supervised program. More generally, such extra checks can be performed by intercepting any code of the supervised program that may not have been used yet. This could occur, for example, for any program language that uses the Java virtual machine (JVM) or for a program language that uses any form of classes or class loading (e.g., a Java or C#program, among others) or a similar function or equivalent stage.

### Code Confirmation

In addition to and/or before using the acceptable behavior model of a first version of the supervised program to determine if a new or second version thereof behaves differently from the first version, a checksum or cryptographically signed digital signature of the first version can be compared to that of the second version. This is an additional type of code verification or confirmation which can quickly determine whether the supervised program or any portion thereof has been changed from the first version to the second version before the second version is run in operation mode.

A typical program commonly consists of many libraries and code sections. Therefore, there are often many libraries associated with the supervised program, such that when the supervised program is run the libraries are also loaded. Although the same libraries might be used in the second version of the supervised program, one or more of the libraries might have been changed. Thus, if a new code has been injected by a changed library function or RCE, then this code confirmation can detect it. This can provide confirmation that the second version (or portions thereof) is the same as the first version (or the corresponding portions thereof) rather than being counterfeit code.

The checksum or digital signature of the first version of the supervised program can be generated before, after, or in parallel with the generation of the acceptable behavior model for the first version in the model-building mode. Then the checksum or digital signature can be stored in or with the acceptable behavior model, so that it can be used in the operation mode with the second version of the supervised program verify that that code of the second version is identical to the code of the first version that was used in the model-building mode. Since the checksum or digital signature is held with the acceptable behavior model, the detection system 100 can rapidly detect whether there's been an undisclosed change in the code of the supervised program and raise a flag at that point.

Code confirmation can potentially detect RepoJacking. RepoJacking (Repository Hijacking) is a type of security attack on a library, code repository, or package management system to gain control over its contents. For example, when a potentially malicious actor creates malicious packages in public package repositories that have the same name as legitimate internal packages (and, in some cases, larger version numbers than the legitimate internal package), a program build system within a target company could potentially download a malicious package from the internet when running package-installation code during the build process.

### Expected Program Behavior

In some cases, the detection system 100 (e.g., using the model explainer described above) can be used to generate an Expected Program Behavior (EPB) report (e.g., the behavior summary). The EPB report is a dynamic report generated from the acceptable behavior model (or just “behavior model”) and has more information than a Software Bill of Materials (SBOM). The SBOM shows static information about a program, such as which libraries are being used, etc. With the acceptable behavior model, on the other hand, in addition to static information, the EPB report can be generated to show “dynamic” information, i.e., actions performed by the program (e.g., file reads/writes, read/write locations, database accesses, port accesses, program spawns, etc.).

For example, if an EPB report had been generated for an acceptable behavior model of the XZ compression utility after the malicious backdoor had been introduced to it in February 2024, the EPB report would show that it spawned a sshd (Secure Shell Daemon) process with which it could have broken sshd authentication and gained unauthorized access to the entire computer system remotely. Thus, the EPB report would have been a good resource with which to detect the security threat in this situation. Thus, the ability to generate a model of a program's behavior (e.g., containing only expected/acceptable behavior or also containing malicious/unacceptable behavior) enables a set of tools that were not previously available for use in securing the software supply chain. As mentioned above, in some cases, the risk profile (mentioned above) of the supervised program can be generated from or based on the EPB report (e.g., the behavior summary from the model explainer). Therefore, if the acceptable behavior model were not available or not readable, the model explainer can support the user in establishing the risk profile of the supervised program by explaining in human terms the behavior captured by acceptable behavior model. (A risk profile of a computer program is an assessment that identifies and evaluates the potential risks associated with the program, including security vulnerabilities, performance issues, and operational challenges. It helps prioritize risks based on their potential impact and likelihood, guiding developers in managing and mitigating these risks effectively.)

### Regulatory Environments

There are many instances where a program's behavior is expected in accordance with regulatory requirements to be tested thoroughly. Thus, the detection system 100 can be used to ensure that the program is behaving as it has in test cases. Any deviation from the expected behavior (e.g., as detected in the operation mode) shows either lack of thoroughness with respect to the test cases or a security problem with the program. The detection system 100 can thereby ensure regulatory compliance, assuming the test cases are adequate.

As an added benefit, the detection system 100 can also indicate when the test cases are not adequate, such as when a behavior is flagged during the operation mode as “unexpected” or “unacceptable” but is in fact acceptable behavior. The flagged behavior might simply be uncommon behavior that the test cases failed to anticipate.

### Control Flow Integrity (CFI) Schemes

Conventional control flow integrity (CFI) schemes are designed to abort a program upon detecting certain forms of undefined behavior that can potentially allow an attacker to subvert the program's control flow. These CFI schemes have typically been optimized for performance, allowing developers to enable them in release builds of the programs.

In general, conventional CFI schemes have been designed to deal with an overwrite of the computer's stack or program space where new instructions can be inserted. Such schemes, however, have not been designed to deal with program remaining consistent across different runs thereof, as with the detection system 100.

Some conventional CFI schemes focus on “type safety”, which ensures that code segments that could be logically undefined, but cannot be validated during compile time (e.g. casting), are validated at runtime. In general, these schemes inject extra security checks into the program during compile time, which means that these schemes are purely development time tools, which add extra security checks to the code during development to detect hypothetically allowed behavior. Thus, these schemes are of no use for an existing program that has already been developed.

The detection system 100, however, can handle such situations, because it focuses on the actual behavior of the program determined after development, not a hypothetically allowed behavior. Thus, the detection system 100 works without regard to how the program was developed or compiled. Instead, the detection system 100 can take an existing program and observe its behavior, without the necessity to add any extra checks for a desired behavior.

### Hardware Supported SYSCALL Interposition

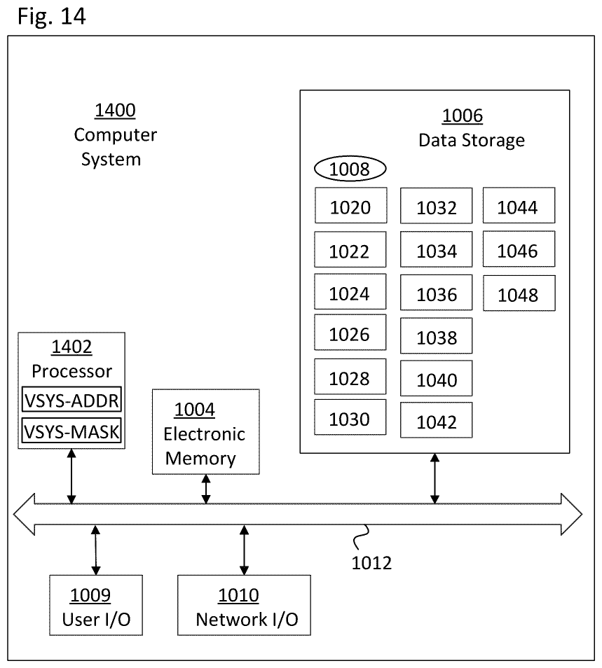

In some cases, a hardware implementation of the detection system 100 uses hardware support for system call interposition. FIG. 14 is a simplified schematic diagram showing an example computer system 1400 (similar to computer system 1000 and representing any combination of one or more of the computer systems) for use in an example hardware implementation of the detection system 100, in accordance with some examples. (Components having the same reference numbers as those of the computer system 1000 may be the same as those components, as described above.) The processor 1402 of the computer system 1400 includes a CPU facility that enables the interception of SYSCALL and then jumps to a handler within the same user process. The CPU facility in the illustrated example includes privileged registers VSYS-ADDR (the address register) and VSYS-MASK (the mask register) that would be maintained per process. (In some cases, these registers could be implemented in CPU microcode firmware.)

When the supervised program 103 is launched, instead of performing specific instrumentation for SYSCALLs of the program, the detection system 100 sets the address and mask registers to point to a user level software interposer for the detection system 100. This enables SYSCALLs made by the supervised program 103 to transition to the interposer to handle and analyze the SYSCALL (i.e., within the context of the sequence of events which the supervised program 103 executed before the SYSCALL) instead of executing as normal SYSCALLs. In the operation mode, the processor running the interposer performs the process 400 (FIG. 4) to generate and analyze the operational sequence of events and determine whether to execute the SYSCALL (the current action) or stop the supervised program. In the model-building mode, the processor running the interposer performs at least part of the process 300 (FIG. 3) to observe or monitor the execution of the supervised program 103 in the captive, isolated, or controlled network environment (in accordance with normal operation without malicious behavior, in the absence of external hostile influences, or with only expected, acceptable or non-malicious behavior) and to generate the instrumentation data for the SYSCALLs.

Whenever the processor is about to execute SYSCALL, the processor determines whether the SYSCALL is coming from the interposer or the supervised program. If the SYSCALL is coming from the supervised program, then the SYSCALL is transitioned to execute the interposer. On the other hand, if the SYSCALL is coming from the interposer, then the SYSCALL is executed as a normal SYSCALL since a SYSCALL from the interposer indicates that the interposer is already being executed.

In some cases, the processor makes the determination of whether the SYSCALL is coming from the interposer or the supervised program by checking whether the program counter (PC) is within the address range of the interposer (i.e., an “interposer address range”). The address register provides the starting address of the interposer, and the mask register provides the range thereof (or a simplified mask therefor), so together they indicate the address range at which the interposer is stored in memory (RAM). Therefore, if the program counter is within the address range, then the SYSCALL originates from within the interposer, so the processor does not intercept the SYSCALL, and the SYSCALL is executed as a normal SYSCALL, i.e., the traditional manner in which SYSCALLs are executed. However, if the program counter is outside the address range, then the SYSCALL is coming from the supervised program (i.e., originates from outside the address range), so the processor intercepts the SYSCALL, and the SYSCALL is transitioned to the interposer (e.g., at the address in the address register). In this manner, instrumentation is performed in hardware rather than in the supervised program itself. This manner of instrumentation can be more efficient than software-based techniques described herein, because the processor 1402 can simply perform a jump to the interposer. Additionally, in some cases, the supervised program does not have to be modified to work with the detection system 100.

In operation mode, when the supervised program is loaded or run, instead of instrumenting the supervised program, the privileged registers are set up. Thus, the SYSCALLs are intercepted, and the processor 1402 branches to the interposer of the detection system 100 to approve or disapprove the SYSCALLs. When operations are transitioned to the interposer, the methods described herein are performed to determine whether the current event (the SYSCALL) is allowable in accordance with the acceptable behavior model or is an anomalous event. When the SYSCALL is determined to be allowable, the SYSCALL is then executed in a normal manner.

### CONCLUSION

Reference has been made in detail to examples of the disclosed invention, one or more examples of which have been illustrated in the accompanying figures. Each example has been provided by way of an explanation of the present technology, not as a limitation of the present technology. In fact, while the specification has been described in detail with respect to specific examples of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
executing, by one or more computer systems, a first version of a program in a first mode of operation in a controlled environment in accordance with a normal operation with only expected behavior;
generating, by the one or more computer systems, a first record of events comprising a first plurality of sequences of events that occur during the normal operation of the first version of the program;
generating, by the one or more computer systems using the first record of events, a first behavior model that is indicative of normal behavior of flow control, flow status, or data flow of actions performed by the first version of the program that occur during the normal operation with only the expected behavior;
executing, by the one or more computer systems, a second version of the program in the first mode of operation in the controlled environment;
generating, by the one or more computer systems, a second record of events comprising a second plurality of sequences of events that occur during operation of the second version of the program in the first mode of operation;
generating, by the one or more computer systems using the second record of events, a second behavior model that is indicative of behavior of flow control, flow status, or data flow of actions performed by the second version of the program that occur during the operation of the second version of the program in the first mode of operation;
determining, by the one or more computer systems, a difference between the second behavior model and the first behavior model;
determining, by the one or more computer systems, that the difference indicates that the second version of the program has a second risk profile that is different from a first risk profile of the first version of the program; and
triggering, by the one or more computer systems, a security review of the second version of the program in response to the second risk profile being different from the first risk profile.

2. The method of claim 1, wherein:
the first behavior model is configured to be used to prevent execution of a current action of the first version of the program in a second mode of operation after the first version of the program has been deployed in runtime in a non-isolated, real-world, operational network environment when it is determined that the current action of the first version of the program is part of an operational sequence of events that does not match the first behavior model.

3. The method of claim 1, wherein:
a difference between the first risk profile and the second risk profile is indicative of a change in function of a component of a software supply chain of the first version of the program and the second version of the program.

4. A method comprising:
receiving, by one or more computer systems, a behavior model that is indicative of operation of flow control, flow status, or data flow of actions performed by a supervised program as determined by execution of the supervised program in a first mode of operation in a controlled environment;
generating, using a model explainer, a behavior summary from information extracted from the behavior model that describes behavior of the program;
generating a risk profile for the supervised program based on the behavior summary, wherein the risk profile identifies potential risks associated with the supervised program.

5. A method comprising:
receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior;
executing, by the one or more computer systems, the program in a second mode of operation after the program has been deployed in runtime in a non-isolated, real-world, operational network environment;
detecting, by the one or more computer systems during the second mode of operation, a delayed event that can be activated upon a condition having been met, wherein the delayed event is detected by a comparison of the acceptable behavior model with an operational sequence of events that includes the delayed event as a current action during the second mode of operation, and the delayed event is not included in the acceptable behavior model; and
not performing the delayed event and generating an alert to stop the executing of the program.

6. The method of claim 5, wherein:
the delayed event is not included in the acceptable behavior model due to the delayed event not having been executed during the first mode of operation.

7. A method comprising:
receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior;
executing, by the one or more computer systems, the program in a second mode of operation after the program has been deployed in runtime in a non-isolated, real-world, operational network environment;
detecting, by the one or more computer systems during the second mode of operation, an event that attempts to execute remote code, wherein the event is detected by a comparison of the acceptable behavior model with an operational sequence of events that includes the event as a current action during the second mode of operation, and the event is not included in the acceptable behavior model; and
not performing the event and generating an alert to stop the executing of the program.

8. The method of claim 7, wherein:
the event is not included in the acceptable behavior model due to the remote code not having been executed during the first mode of operation.

9. The method of claim 7, wherein the program is a Java program or a C#program, and the event occurs during class loading.

10. A method comprising:
executing, by one or more computer systems, a program in a first mode of operation in a controlled environment in accordance with an expected operation with only expected behavior;
generating, by the one or more computer systems, a training record of events comprising a plurality of training sequences of events that occur during the expected operation of the program;
generating, by the one or more computer systems using the training record of events, an acceptable behavior model that is indicative of expected behavior of flow control, flow status, or data flow of actions performed by the program that occur during the expected operation with only the expected behavior;
executing, by the one or more computer systems, the program in a second mode of operation after the program has been deployed in runtime in a non-isolated, real-world, operational network environment;
determining, by the one or more computer systems, an operational record of events comprising a plurality of operational sequences of events that occur during the executing of the program in the second mode of operation, each operational sequence of events being obtained at one of a plurality of levels of instrumentation detail, a first level of instrumentation detail being different from a second level of instrumentation detail of the plurality of levels of instrumentation detail, and a first operational sequence of events of the plurality of operational sequences of events including a first current action;
comparing, by the one or more computer systems, the first operational sequence of events with the acceptable behavior model;
when the comparing step results in a match between the first operational sequence of events and the acceptable behavior model, performing the first current action in the second mode of operation; and
when the comparing step does not result in the match between the first operational sequence of events and the acceptable behavior model, not performing the first current action and generating an alert to stop the executing of the program.

11. The method of claim 10, wherein:
the first operational sequence of events corresponds to a first training sequence of events of the plurality of training sequences of events;
for each training sequence of events, each level of instrumentation detail is different from other levels of instrumentation detail; and
the first operational sequence of events and the first training sequence of events are obtained at the first level of instrumentation detail of the plurality of levels of instrumentation detail.

12. The method of claim 10, wherein:
each training sequence of events of the plurality of training sequences of events is obtained at a first level of instrumentation detail of the plurality of levels of instrumentation detail; and
each operational sequence of events is obtained at the first level of instrumentation detail or a lower level of instrumentation detail of the plurality of levels of instrumentation detail.

13. The method of claim 10, wherein:
the training record of events comprises a first training sequence of events and a second training sequence of events of the plurality of training sequences of events;
the first operational sequence of events and the first training sequence of events are obtained at a first level of instrumentation detail of the plurality of levels of instrumentation detail;
the second training sequence of events is obtained at a second level of instrumentation detail;
and the second level of instrumentation detail is greater than the first level of instrumentation detail; and
the method further comprises:
determining, by the one or more computer systems, a second operational sequence of events of the plurality of operational sequences of events during the executing of the program in the second mode of operation, the second operational sequence of events including a second current action, the second operational sequence of events corresponding to the second training sequence of events, and the second operational sequence of events being obtained at the second level of instrumentation detail;
comparing, by the one or more computer systems, the second operational sequence of events with the acceptable behavior model;
when the comparing step results in a match between the second operational sequence of events and the acceptable behavior model, performing the second current action in the second mode of operation; and
when the comparing step does not result in the match between the second operational sequence of events and the acceptable behavior model, not performing the second current action and generating the alert to stop the executing of the program.

14. The method of claim 10, wherein:
the program has a plurality of types of program sections including a first type of program section and a second type of program section;
each training sequence of events and each operational sequence of events obtained from the first type of program section are obtained at the first level of instrumentation detail;
each training sequence of events and each operational sequence of events obtained from the second type of program section are obtained at the second level of instrumentation detail.

15. The method of claim 14, wherein:
the first type of program section is a first Java class or a first C#class; and
the second type of program section is a second Java class or a second C#class.

16. A method comprising:
receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior;
executing, by the one or more computer systems, the program in a second mode of operation after the program has been deployed in runtime in a non-isolated, real-world, operational network environment;
determining, by the one or more computer systems, an operational sequence of events of the program during execution of the program in the second mode of operation, the operational sequence of events including a current action, and the operational sequence of events being generated from a stacktrace;
comparing, by the one or more computer systems, the operational sequence of events with the acceptable behavior model;
when the comparing step results in a match between the operational sequence of events and the acceptable behavior model, performing the current action in the second mode of operation; and
when the comparing step does not result in the match between the operational sequence of events and the acceptable behavior model, not performing the current action and generating an alert to stop the executing of the program.

17. The method of claim 16, wherein:
the acceptable behavior model has been generated from a plurality of training sequences of events that have been generated from the stacktrace.

18. A method comprising:
receiving, by one or more computer systems, an acceptable behavior model that is indicative of normal operation of flow control, flow status, or data flow of actions performed by a program with only expected behavior as determined by execution of the program in a first mode of operation in a controlled environment in accordance with the normal operation with only expected behavior;
executing, by the one or more computer systems, the program in a second mode of operation after the program has been deployed in runtime in a non-isolated, real-world, operational network environment;
determining, by the one or more computer systems, an operational sequence of events of the program during execution of the program in the second mode of operation, the operational sequence of events including a current action, the current action including a SYSCALL, the SYSCALL being intercepted by a processor of the one or more computer systems, and the processor transitioning to an interposer to generate the operational sequence of events upon intercepting the SYSCALL;
comparing, by the processor running the interposer, the operational sequence of events with the acceptable behavior model;
when the comparing step results in a match between the operational sequence of events and the acceptable behavior model, performing the current action in the second mode of operation; and
when the comparing step does not result in the match between the operational sequence of events and the acceptable behavior model, not performing the current action and generating an alert to stop the executing of the program.

19. The method of claim 18, wherein:
the interposer is stored within an interposer address range in a memory; and
the processor intercepts the SYSCALL upon determining that the SYSCALL originates from outside the interposer address range.

20. The method of claim 19, wherein:
if the processor determines that the SYSCALL originates from within the interposer address range, the processor does not intercept the SYSCALL or transition to the interposer.

21. The method of claim 20, wherein:
an address register provides a starting address of the interposer;
a mask register provides a range of the interposer; and
the interposer address range is indicated by the starting address and the range together.
